(19) United States
(12) Patent Application Publication
(10) Pub. No.: US 2019/0230388 A1
(43) Pub. Date: Jul. 25, 2019

(54) METHOD AND APPARATUS FOR PROCESSING VIDEO DATA

(71) Applicant: HUAWEI TECHNOLOGIES CO., LTD., Shenzhen, (CN)

(72) Inventors: Peiyun DI, Shenzhen (CN); Qingpeng XIE, Shenzhen (CN)

(73) Assignee: HUAWEI TECHNOLOGIES CO., LTD., Shenzhen (CN)

(21) Appl. No.: 16/370,052

(22) Filed: Mar. 29, 2019

Related U.S. Application Data
(63) Continuation of application No. PCT/CN2017/086548, filed on May 31, 2017.

(30) Foreign Application Priority Data
Sep. 30, 2016 (CN) 201610878496.1
Oct. 11, 2016 (CN) 201610890964.7

(51) Int. Cl. H04N 21/235; H04N 21/2343; H04N 21/845; H04N 21/2662

(52) U.S. Cl. CPC H04N 21/2353; H04N 21/2662; H04N 21/8456; H04N 21/23439

(57) ABSTRACT

A method and an apparatus for processing video data. The method includes: parsing media presentation description to obtain flag information, where the flag information is used to identify a first representation of a video, where playing duration of a segment in the first representation is shorter than playing duration of a segment in a second representation of the video; obtaining switching instruction information, where the switching instruction information is used to instruct to switch from a current spatial object to a target spatial object; determining a target representation from the first representation of the video based on the flag information and the switching instruction information, where the target representation corresponds to the target spatial object; and obtaining a current playing moment of the video, and obtaining a target representation segment based on the current playing moment and the target representation.

### CROSS-REFERENCE TO RELATED APPLICATIONS

This application is a continuation of International Application No. PCT/CN2017/086548, filed on May 31, 2017, which claims priority to Chinese Patent Applications No. 201610890964.7, filed on Oct. 11, 2016, and Chinese Patent Application No. 201610878496.1, filed on Sep. 30, 2016. All of the aforementioned patent applications are hereby incorporated by reference in their entireties.

### TECHNICAL FIELD

The present disclosure relates to the field of streaming media data processing, and in particular, to a method and an apparatus for processing video data.

### BACKGROUND

With ongoing development and improvement of a virtual reality (virtual reality, VR) technology, users have witnessed emergence of an increasing quantity of applications for watching VR videos with a 360-degree viewport. When a user watches a VR video, a viewport (viewport, FOV) of a user may be changed at any time, and a VR video image that appears in the viewport of the user should be switched accordingly. In VR applications, regarding user experience in the foregoing application scenario, the user needs to see rapidly a new picture after switching, and the new picture needs to have high quality. Therefore, how to implement efficient and high-quality switching between VR video images is one of problems that urgently need to be resolved in processing of video stream data in VR applications.

A panoramic space for VR video watching is divided into a plurality of spatial objects in the prior art, and a group of dynamic adaptive streaming over Hypertext Transfer Protocol (hypertext transfer protocol, HTTP) (dynamic adaptive streaming over HTTP, DASH) streams are prepared for each spatial object. When a viewport of a user is changed, a terminal selects a DASH stream of a spatial object corresponding to a switch-to viewport for playing, to switch between video images of different fields of view. A DASH stream corresponding to each region includes a plurality of segments (segment). Switching between video images is represented by switching between playing of segments. During viewport switching, playing of a currently played segment needs to be implemented before a next segment can be played. A manner of switching between segments in streams representing different video quality is specified in the existing MPEG-DASH standard approved by the Moving Picture Experts Group (Moving Picture Experts Group, MPEG) organization. However, in most existing applications, duration (duration) of each segment is 5 seconds or longer. Therefore, during viewport switching, the user may need to wait 5 seconds to see a picture of a new switch-to viewport. However, in VR applications, users feel discomfort if latency in viewport switching exceeds 200 ms. Therefore, users feel discomfort due to a time interval of five seconds, the terminal has poor user experience, and VR video watching has a poor effect.

### SUMMARY

I. Introduction of MPEG-DASH Technology

The MPEG organization approved the DASH standard in November, 2011. The DASH standard is a technical specification of transmitting media streams over the HTTP protocol (referred to as DASH technical specification below). The DASH technical specification mainly includes a media presentation description (Media Presentation Description, MPD) and a media file format (file format).

1. Media File Format

A plurality of versions of streams are prepared for same video content on a server in DASH. Each version of stream is referred to as a representation (representation) in the DASH standard. A representation is a collection and an encapsulation of one or more streams in a delivery format. A representation includes one or more segments. Different versions of streams may have different encoding parameters such as bitrates and resolutions. Each stream is segmented into a plurality of small files. Each small file is referred to as a segment (segment). As a client requests media segment data, switching between different representations may be performed. As shown in FIG. 3, three representations including a rep 1, a rep 2, and a rep 3 are prepared for a movie on a server. The rep 1 is a high-resolution video having a bitrate of 4 mbps (megabits per second), the rep 2 is a standard-resolution video having a bitrate of 2 mbps, and the rep 3 is a standard-resolution video having a bitrate of 1 mbps. Shaded segments in FIG. 3 are segment data that the client requests to play. The first three segments requested by the client are segments in the representation rep 3. The client switches to the rep 2 for the fourth segment to request the fourth segment, then switches to the rep 1 to request the fifth segment and the sixth segment, and switches on. The segments in the representations may be connected head to tail and stored in one file, or may be independently stored in individual small files. The segments may be encapsulated according to a format (ISO BMFF (Base Media File Format)) in the standard ISO/IEC 14496-12 or may be encapsulated according to a format (MPEG-2 TS) in ISO/IEC 13818-1.

2. Media Presentation Description

In the DASH standard, a media presentation description is referred to as an MPD. The MPD may be an XML file. Information in the file is described in a leveled manner. As shown in FIG. 2, information on a high level is inherited completely by a lower level. Some media metadata is described in the file. A client may learn of media content information on a server from the metadata, and may use the information to construct an http-URL for requesting a segment.

In the DASH standard, media presentation (media presentation) is a collection of structured data for presenting media content. A media presentation description (media presentation description) is a file of a formalized description for a media presentation for the purpose of providing a streaming service. For a period (period), a group of contiguous periods constitute an entire media presentation. A period has a contiguous property and a non-overlapping property. A representation (representation) is a collection of structured data that encapsulates one or more media content components (encoded separate media types such as an audio type or a video type) having descriptive metadata. a representation is a collection and an encapsulation of one or more streams in a delivery format. A representation includes one or more segments. An adaptation set (AdaptationSet) represents a set of a plurality of interchangeable encoded versions of a same media content component. An adaptation set includes one or more representations. A subset (subset) is a group of adaptation sets. When playing all the adaptation sets in the group, a player may obtain corresponding media content. Segment information is a media element referenced by an HTTP Uniform Resource Locator in the media presentation description. The segment information describes segments of media data. The segments of the media data may be stored in one file or may be stored separately. In a possible manner, the segments of the media data are stored in an MPD.

For related technical concepts about the MPEG-DASH technology in the present disclosure, refer to related specifications in ISO/IEC 23009-1:2014 Information technology—Dynamic adaptive streaming over HTTP (DASH)—Part 1: Media presentation description and segment formats, or refer to related specifications in the historical versions of the standard, for example, ISO/IEC 23009-1:2013 or ISO/IEC 23009-1:2012.

II. Introduction of Virtual Reality (Virtual Reality, VR) Technology

The virtual reality technology provides a computer simulation system that can be used to create and experience a virtual world. The computer simulation system uses a computer to generate a simulated environment that incorporates information from various sources and implements interactive system simulation of three-dimensional dynamic vision and physical behaviors to immerse a user in the environment. VR mainly includes aspects such as environment simulation, perception, natural skills, and sensing devices. The simulated environment means computer-generated, real-time, dynamic, three-dimensional, and realistic images. The perception means that ideal VR should engage all senses that a person possesses. In addition to visual perception generated by using a computer graphics technology, there are auditory perception, haptic perception, force perception, kinesthetic perception, and the like, or there are even olfactory perception, gustatory perception, and the like. Such VR is referred to as multisensory VR. The natural skills mean head movements, eye movements, gestures, or other physical behavior and actions of a person. The computer processes data that adapts to actions of a participant, makes real-time responses to inputs of a user, and sends feedbacks to five sensor organs of the user. The sensing device means a three-dimensional interactive device. When a VR video (or a 360-degree video, or an omnidirectional video (Omnidirectional video)) is presented on a head-mounted device and a handheld device, only a video image of a part at a position corresponding to the head of a user and related audio are presented.

A difference between a VR video and a normal video (normal video) lies in that entire video content of a normal video is presented to a user while only a subset of an entire VR video is presented to a user (in VR typically only a subset of the entire video region represented by the video pictures).

III. Spatial Description of Existing DASH Standard:

In the existing standard, the original description of spatial information is “The SRD scheme allows Media Presentation authors to express spatial relationships between Spatial Objects. A Spatial Object is defined as a spatial part of a content component (e.g. a region of interest, or a tile) and represented by either an Adaptation Set or a Sub-Representation.”

[Chinese]: An MPD describes spatial relationships (spatial relationships) between spatial objects (Spatial Objects). A spatial object is defined as a spatial part of a content component, and is, for example, an existing region of interest (region of interest, ROI), and a tile. A spatial relationship may be described in an Adaptation Set and a Sub-Representation.

Some descriptor elements are defined in the MPD in the existing DASH standard. Each descriptor element has two attributes: a schemeIdURI and a value. The schemeIdURI describes what a current descriptor is, and the value is a parameter value of the descriptor.

There are two existing descriptors SupplementalProperty and EssentialProperty (a supplemental property descriptor and an essential property descriptor) in the existing standard. In the existing standard, if schemeIdURI of the two descriptors is equal to “urn:mpeg:dash:srd:2014” (or schemeIdURI is equal to urn:mpeg:dash:VR:2017), it indicates that the descriptors describe spatial information associated with a spatial object (spatial information associated with the containing Spatial Object.), and a series of parameter values of SDR are listed in corresponding values. Syntax of specific values is shown in Table 1 below:

TABLE 1

| EssentialProperty@value or | | |
|---|---|---|
| SupplementalProperty@ | | |
| value parameter | Use | Description |
| source_id | M | Non-negative integer, providing a content source identifier |
| x | M | non-negative integer in decimal representation expressing the |
| | | horizontal position of the top-left corner of the Spatial Object |
| | | in arbitrary units |
| | | Horizontal position of the top-left corner of the spatial object |
| | | in arbitrary units |
| y | M | non-negative integer in decimal representation expressing the |
| | | vertical position of the top-left corner of the Spatial Object in |
| | | arbitrary units |
| | | Vertical position of the top-left corner of the spatial object |
| w | M | non-negative integer in decimal representation expressing the |
| | | width of the Spatial Object in arbitrary units |
| | | Width of the spatial object |
| h | M | non-negative integer in decimal representation expressing the |
| | | height of the Spatial Object in arbitrary units |
| | | Height of the spatial object |
| W | O | optional non-negative integer in decimal representation |
| | | expressing the width of the reference space in arbitrary units. |
| | | Width of the reference space |
| | | When the value W is present, the value H shall be present. |
| H | O | Height of the reference space. |
| spatial_set_id | O | optional non-negative integer in decimal representation |
| | | providing an identifier for a group of Spatial Object. |
| | | Group of the spatial object |

Legend:
M = Mandatory,
O = Optional

FIG. 6 is a schematic diagram of a spatial relationship among spatial objects. An image AS may be set as a content component. AS1, AS2, AS3, and AS4 are four spatial objects included in the AS. Each spatial object is associated with a space. A spatial relationship among the spatial objects, for example, a relationship among spaces associated with the spatial objects, is described in an MPD.

An MPD sample is as follows:

<?xml version=“1.0” encoding=“UTF-8”?>

```
<MPD
  xmlns:xsi=“http://www.w3.org/2001/XMLSchema-instance”
  xmlns=“urn:mpeg:dash:schema:mpd:2011”
  xsi:schemaLocation=“urn:mpeg:dash:schema:mpd:2011
  DASH-MPD.xsd”
  [...]>
  <Period>
```

<AdaptationSet...]>

<SupplementalProperty schemeIdUri=“urn:mpeg:dash:srd:2014”

value=“1, 0, 0, 1920, 1080, 1920, 1080, 1”/><!—A video source identifier: 1; coordinates of a top-left corner of a spatial object is (0, 0); a length and a width of the spatial object are (1920, 1080); a reference space of the spatial object is (1920, 1080); and a spatial object group ID is 1. Here, a size of the spatial object is equal to that of the reference space of the spatial object, and therefore the representation in a representation 1 (id=1) corresponds to entire video content.->

<Representation id=“1” bandwidth=“1000000” >

<BaseURL>video-1.mp4</BaseURL>

```
  </Representation>
  ...
  <Representation id=“11” bandwidth=“3000000” >
```

<BaseURL>video-11.mp4</BaseURL>

</Representation>

</AdaptationSet>

<AdaptationSet [...]>

<EssentialProperty schemeIdUri=“urn:mpeg:dash:srd:2014”

value=“1, 0, 0, 1920, 1080, 3840, 2160, 2”/><!—A video source identifier: 1 (a content source that is the same as the video source above); coordinates of a top-left corner of a spatial object is (0, 0); a length and a width of the spatial object are (1920, 1080); a reference space of the spatial object is (3840, 2160); and a spatial object group ID is 2. Here, a size of the spatial object is one fourth of that of the reference space of the spatial object, and the spatial object is the spatial object at the top-left corner as seen from the coordinates, the AS1. Content of the representation AS1 in a representation 2. Similarly, the descriptions of other spatial objects are similar to the following description of a related descriptor. Spatial objects with the same spatial object group IDs belong to the same video content->

<Representation id=“2” bandwidth=“4500000”>

<BaseURL>video-2.mp4</BaseURL>

</Representation>

</AdaptationSet>

<AdaptationSet [...]>

<EssentialProperty schemeIdUri=“urn:mpeg:dash:srd:2014”

value=“1, 1920, 0, 1920, 1080, 3840, 2160, 2”/>

<Representation id=“video-3” bandwidth=“2000000”>

<BaseURL>video-3.mp4</BaseURL>

</Representation>

</AdaptationSet>

[...]

<AdaptationSet [...]>

<EssentialProperty schemeIdUri=“urn:mpeg:dash:srd:2014”

```
  value=“1, 1920, 1080, 1920, 1080, 3840, 2160,
  2”/>
```

<Representation id=“5” bandwidth=“1500000”>

<BaseURL>video-5.mp4</BaseURL>

</Representation>

</AdaptationSet>

<!-- Last level -->

<AdaptationSet [...]>

<EssentialProperty schemeIdUri=“urn:mpeg:dash:srd:2014”

value=“1, 0, 0, 1920, 1080, 7680, 4320, 3”/>

<Representation id=“6” bandwidth=“3500000”>

<BaseURL>video-6.mp4</BaseURL>

</Representation>

</AdaptationSet>

[...]

<AdaptationSet [...]>

<EssentialProperty schemeIdUri=“urn:mpeg:dash:srd:2014”

```
  value=“1, 5760, 3240, 1920, 1080, 7680, 4320,
  3”/>
```

<Representation id=“21” bandwidth=“4000000”>

<BaseURL>video-21.mp4</BaseURL>

</Representation>

</AdaptationSet>

</Period>

</MPD>

The coordinates of the top-left corner of the spatial object, the length and width of the spatial object, and the reference space of the spatial object may alternatively have relative values. For example, the foregoing value “1, 0, 0, 1920, 1080, 3840, 2160, 2” may be described as a value=“1, 0, 0, 1, 1, 2, 2, 2”.

In some feasible implementations, for output of a 360-degree large viewport video image, a server may divide a space in a 360-degree viewport range to obtain a plurality of spatial objects. Each spatial object corresponds to a sub-viewport, one sub-viewport is used or a plurality of sub-fields of view are spliced to form a complete viewport for observation by human eyes. A viewport for observation by human eyes is normally 120 degrees*120 degrees, and is, for example, a field 1 of view corresponding to a box 1 and a field 2 of view corresponding to a box 2 shown in FIG. 7. The server may prepare a group of video streams for each spatial object. the server may obtain an encoding configuration parameter of each stream in a video, and generate the stream corresponding to each spatial object of the video based on the encoding configuration parameter of the stream. A client may request a video stream segment corresponding to a viewport in a time period from the server during output of the video and output the video stream segment to a spatial object corresponding to the viewport. The client outputs, in a same time period, video stream segments corresponding to all fields of view in the 360-degree viewport range, so that a complete video image in the time period can be output and displayed in the entire 360-degree spatial object.

In a implementation, in the division of the 360-degree spatial object, the client may first map a spherical surface into a plane, and divide the spatial object in the plane. the client may map the spherical surface into a latitude-longitude plan in a manner of latitude-longitude mapping. FIG. 9 is a schematic diagram of a spatial object according to an embodiment of the present disclosure. The client may map the spherical surface into the latitude-longitude plan, and divide the latitude-longitude plan into a plurality of spatial objects A to I. Further, the client may alternatively map the spherical surface into a cube, and then unfold a plurality of surfaces of the cube to obtain a plan, or map the spherical surface into another polyhedron, and unfold a plurality of surfaces of the polyhedron to obtain a plan. The client may further map the spherical surface into a plane in other mapping manners, and a mapping manner may be determined according to a requirement in an actual application scenario and is not limited herein. The description is provided below by using the manner of latitude-longitude mapping and with reference to FIG. 10.

As shown in FIG. 10, after the client divides the spatial object of the spherical surface into the plurality of spatial objects A to I, the server may prepare a group of DASH streams for each spatial object. Each spatial object corresponds to a sub-viewport. A group of DASH streams corresponding to each spatial object are viewport streams of each sub-viewport. Spatial objects associated with images in one viewport stream have the same spatial information, so that the viewport stream is set as a static stream. During playing of the video, a DASH stream corresponding to a corresponding spatial object may be selected based on a current viewport used by a user to watch the video for playing. When the user switches fields of view used by the user to watch the video, the client may determine, based on a new viewport selected by the user, a DASH stream corresponding to a target spatial object of switching, so that video playing content can be switched to the DASH stream corresponding to the target spatial object.

Nine viewport streams of a rep A to a rep I in FIG. 10 correspond respectively to the nine spatial objects A to I in the latitude-longitude view. The rep A is any one in the group of DASH streams corresponding to the spatial object A. In this embodiment of the present disclosure, the rep A is used as an example for description. Similarly, a sub-viewport stream in each of the rep B to the rep I is respectively any one in a group of DASH streams corresponding to a spatial object corresponding to each of the rep B to the rep I. In this embodiment of the present disclosure, the rep B, the rep C, and the rep I are used as an example for description. Segments included in viewport streams of each sub-viewport are aligned. segments included in viewport streams in a same time period have the same length. Segments in different viewport streams are aligned, so that for the different viewport streams, video images of segments may be switched as fields of view are switched. For example, the user switches to the fourth segment in the rep B after playing of the third segment in the rep D is implemented, and subsequently switches to the sixth segment in the rep C after playing of the fifth segment in the rep B is implemented. A video image presented by the client is switched from a picture of a field D of view to a picture of a field B of view, and is then switched to a picture of a field C of view.

This embodiment of the present disclosure provides a switching stream whose segment duration is different from that of a viewport stream. Playing duration corresponding to a segment included in the switching stream is shorter than playing duration of a segment included in a viewport stream corresponding to the switching stream. Each group of switching streams corresponds to a group of viewport streams (where as shown in FIG. 11, the rep A represents a group of viewport streams, and the rep A′ represents a group of switching streams). The group of switching streams includes one or more switching streams, and each group of switching streams corresponds to a spatial object. A switching stream and a viewport stream corresponding to the switching stream correspond to a same spatial object. stream segments in a same time period that are included in the switching stream and the viewport stream corresponding to the switching stream have the same content component.

In some feasible implementations, when preparing a viewport stream for video stream data, the server additionally prepares a group of switching streams for each sub-viewport. each group of viewport streams corresponds to a group of switching streams. Each group of viewport streams and switching streams corresponding to the viewport streams include the same sub-viewport (that is, have the same spatial object), and a difference is only that a segment in a viewport stream has relatively long duration and a segment in a switching stream has relatively short duration. When a viewport of the user needs to be switched, the client first selects a switching stream. In this way, the client presents a high-quality video in a new viewport after a very short time. When the client detects that the client can switch from a segment in the switching stream to a viewport stream, a representation of the client is switched from the switching stream to the viewport stream. In this way, optimal experience can be ensured for the user under a same bandwidth condition.

In this embodiment of the present disclosure, to enable a client to identify a switching stream, when generating an MPD, the server needs to add a syntax element corresponding to the switching stream, and the client may obtain, based on the syntax element, switching stream information corresponding to the viewport stream. When generating the MPD, the server may add, to the MPD, a representation used to describe the switching stream. The representation may include description information of one or more switching streams. The representation may be alternatively referred to as a switching stream representation or referred to as a first representation. An existing representation used to describe a viewport stream in the MPD may be referred to as a viewport stream representation or a media representation or a second representation. When the viewport of the user needs to be switched, a stream of a new viewport can be selected rapidly, to present a high-quality video in the new viewport. Several possible representation manners of the syntax element of the MPD are as follows. It may be understood that an MPD example in this embodiment of the present disclosure merely shows related parts in which syntax elements of an MPD that are specified in the existing standard are changed in the technology of the present disclosure, but does not show all syntax elements of an MPD file. Persons of ordinary skill in the art may use technical solutions in this embodiment of the present disclosure in combination with related specifications in the DASH standard.

In an implementation of this embodiment of the present disclosure, a syntax description is added to an MPD. Table 2 is a syntax information table:

| | Character | |
|---|---|---|
| Character | attribute | Character description |
| (Parameters) | (Use) | (Description) |
| FovType | O | Indicate whether a corresponding description |
| | | is a switching stream, and a default value is 0; |
| | | 0 indicates a non-switching stream (that is, a |
| | | viewport stream) |
| | | 1 indicates a switching stream |

Legend (Legend):
M = Mandatory (mandatory),
O = Optional (in a feasible implementation)

The attribute @FovType is used in the MPD to mark a switching stream in a corresponding representation. When parameters such as a viewport and a bitrate are the same, the client preferentially uses a representation representing a switching stream to present a new viewport. A related MPD example is as follows:

MPD Sample 1:

<?xml version=“1.0” encoding=“UTF-8”?>

<MPD

xmlns=“urn:mpeg:dash:schema:mpd:2011”
type=“static”
mediaPresentationDuration=“PT10S”
minBufferTime=“PT1S”
profiles=“urn:mpeg:dash:profile:isoff-on-demand:2011”>
<Period>
<AdaptationSet id=“1” segmentAlignment=“true” subsegmentAlignment=“true”

subsegmentStartsWithSAP=“1”>

```
<Role schemeIdUri=“urn:mpeg:dash:role:2011” value=“main”/>
<EssentialProperty schemeIdUri=“urn:mpeg:dash:xxx:201x” value=“xx”/>
<Representation id=“fov1” mimeType=“video/mp4” width=“960” height=“480”...>
  <BaseURL> main_960x480.mp4</BaseURL>
  ...
```

</Representation>

</AdaptationSet>

| | | |
|---|---|---|
| <AdaptationSet | id=“2”segmentAlignment=“true” | subsegmentAlignment=“true” |

subsegmentStartsWithSAP=“1”>

<Representation id=“author1” mimeType=“video/mp4” width=“960” height=“480” FOV_type

=“1”>

```
  <BaseURL>switch_960x480.mp4</BaseURL>
  ...
```

</Representation>

...

</AdaptationSet>

</Period>

</MPD>

In this MPD sample, a representation whose representation id is equal to “author1” is a switching stream.

MPD Sample 2:

<?xml version=“1.0” encoding=“UTF-8”?>

<MPD

xmlns:xsi=“http://www.w3.org/2001/XMLSchema-instance”
xmlns=“urn:mpeg:dash:schema:mpd:2011”
xsi:schemaLocation=“urn:mpeg:dash:schema:mpd:2011
DASH-MPD.xsd”
[...]>
<Period>
<AdaptationSet [...]>

<SupplementalProperty schemeIdUri=“urn:mpeg:dash:xx:201x”

value=“1, 0, 0, 1920, 1080, 1920, 1080, 1”/>

<Representation id=“1” bandwidth=“1000000” >

<BaseURL>video-1.mp4</BaseURL>

</Representation>

</AdaptationSet>

<AdaptationSet [...]>

<EssentialProperty schemeIdUri=“urn:mpeg:dash:xx:201x”

value=“1, 0, 0, 1920, 1080, 3840, 2160, 2”/>

<!-Viewport stream-->
<Representation id=“2” bandwidth=“4500000”>

<BaseURL>video-2.mp4</BaseURL>

</Representation>
<!--Switching stream-->
<Representation id=“3” bandwidth=“4500000” fovType=“1”>

<BaseURL>video-3.mp4</BaseURL>

</Representation>

</AdaptationSet>

</Period>
</MPD>

In this MPD sample, a representation whose representation id is equal to “3” is a switching stream.

In another implementation of this embodiment of the present disclosure,

MPD Sample 3:

<?xml version=“1.0” encoding=“UTF-8”?>

<MPD

xmlns:xsi=“http://www.w3.org/2001/XMLSchema-instance”
xmlns=“urn:mpeg:dash:schema:mpd:2011”
xsi:schemaLocation=“urn:mpeg:dash:schema:mpd:2011
DASH-MPD.xsd”
[...]>
<Period>
<AdaptationSet [...]>

<SupplementalProperty schemeIdUri=“urn:mpeg:dash:xx:201x”

value=“1, 0, 0, 1920, 1080, 1920, 1080, 1”/>

<Representation id=“1” bandwidth=“1000000” >

<BaseURL>video-1.mp4</BaseURL>

</Representation>

```
  </AdaptationSet>
  <AdaptationSet id=“1”[...]> <!--Viewport stream-->
```

<EssentialProperty schemeIdUri=“urn:mpeg:dash:xx:201x”

value=“1, 0, 0, 1920, 1080, 3840, 2160, 2”/>

<Representation id=“2” bandwidth=“4500000”>

<BaseURL>video-2.mp4</BaseURL>

</Representation>

</AdaptationSet>
<AdaptationSet id=“2” [...] fovType=“1”> <!--Switching stream-->

<EssentialProperty schemeIdUri=“urn:mpeg:dash:xx:201x”

value=“1, 0, 0, 1920, 1080, 3840, 2160, 2”/>

<Representation id=“3” bandwidth=“4500000” >

<BaseURL>video-3.mp4</BaseURL>

</Representation>

</AdaptationSet>

</Period>
</MPD>

In this MPD sample, all representations in lower layers of an adaptation set whose adaptation set id is equal to “2” are switching streams.

Another embodiment of this embodiment of the present disclosure provides another description manner of the switching stream in the MPD. Table 3 is another syntax information table:

TABLE 3

| Parameters | Use | Description |
|---|---|---|
| Switch- | O | Used to describe a representation, and a stream |
| representation | | marked with a switch-representation description |
| | | is a switching stream. |

Legend:
M = Mandatory,
O = Optional

The foregoing representation marked with switch-representation has the same content as other representations that belong to one adaptation set. However, seamless switching cannot be performed between all segments in the representation and segments in the other representations. Switching can be performed between the representation and other representations only at a specified segment. It indicates that the representation is a switching stream. During viewport switching, the client first obtains a segment in the representation for presentation in a new viewport.

A related MPD example is as follows:

MPD Sample 4:

<?xml version=“1.0” encoding=“UTF-8”?>

<MPD

xmlns:xsi=“http://www.w3.org/2001/XMLSchema-instance”
xmlns=“urn:mpeg:dash:schema:mpd:2011”
xsi:schemaLocation=“urn:mpeg:dash:schema:mpd:2011
DASH-MPD.xsd”
[...]>
<Period>
<AdaptationSet [...]>

<SupplementalProperty schemeIdUri=“urn:mpeg:dash:xx:201x”

value=“1, 0, 0, 1920, 1080, 1920, 1080, 1”/>

<Representation id=“1” bandwidth=“1000000” >

<BaseURL>video-1.mp4</BaseURL>

</Representation>

</AdaptationSet>

<AdaptationSet [...]>

<EssentialProperty schemeIdUri=“urn:mpeg:dash:xx:201x”

value=“1, 0, 0, 1920, 1080, 3840, 2160, 2”/>

<!--Viewport stream-->
<Representation id=“2” bandwidth=“4500000”>

<BaseURL>video-2.mp4</BaseURL>

</Representation>
<!--Switching stream-->
< switch-representation id=“3” bandwidth=“4500000” >

<BaseURL>video-3.mp4</BaseURL>

</Representation>

</AdaptationSet>

</Period>
</MPD>

In this MPD sample, a representation whose switch-representation id is equal to “3” is a switching stream. A new representation type switch-representation is added in this embodiment of the present disclosure.

In another implementation of this embodiment of the present disclosure, a new syntax element is added to the MPD to group representations. One group includes representations specified in the existing DASH standard, and another group includes representations of switching streams. A related MPD example is as follows:

MPD Sample 5:

<?xml version=“1.0” encoding=“UTF-8”?>

<MPD

xmlns:xsi=“http://www.w3.org/2001/XMLSchema-instance”
xmlns=“urn:mpeg:dash:schema:mpd:2011”
xsi:schemaLocation=“urn:mpeg:dash:schema:mpd:2011
DASH-MPD.xsd”
[...]>
<Period>

<AdaptationSet [...]>

<SupplementalProperty schemeIdUri=“urn:mpeg:dash:srd:2014”

value=“1, 0, 0, 1920, 1080, 1920, 1080, 1”/>

<Representation id=“1” bandwidth=“1000000” >

<BaseURL>video-1.mp4</BaseURL>

</Representation>

</AdaptationSet>

<AdaptationSet [...]>

<EssentialProperty schemeIdUri=“urn:mpeg:dash:srd:2014”

value=“1, 0, 0, 1920, 1080, 3840, 2160, 2”/>

<!--Viewport stream-->

```
  <Representation id=“2” bandwidth=“450000”
  FovGroup=“1”> >
```

<BaseURL>video-2.mp4</BaseURL>

</Representation>

<!--Switching stream-->
<Representation id=“3” bandwidth=“4500000” FovGroup =“2”
fovType=“1”>

<BaseURL>video-3.mp4</BaseURL>

</Representation>

</AdaptationSet>

<AdaptationSet [...]>

<EssentialProperty schemeIdUri=“urn:mpeg:dash:srd:2014”

value=“1, 1920, 0, 1920, 1080, 3840, 2160, 2”/>

<!--Viewport stream-->
<Representation id=“4” bandwidth=“450000” FovGroup=“1”>

<BaseURL>video-4.mp4</BaseURL>

</Representation>
<!--Switching stream-->
<Representation id=“5” bandwidth=“4500000” FovGroup =“2”>

<BaseURL>video-5.mp4</BaseURL>

</Representation>

</AdaptationSet>

</Period>

</MPD>

In the MPD, grouping information is added to representations, and a group of switchable segments may be obtained according to the grouping information. For example, FovGroup of a representation whose representation id is equal to “3” and FovGroup of a representation whose representation id is equal to “5” are equal to “2”, and segments in the two representations are all aligned and the client can switch between the segments.

Embodiments of the present disclosure provide a method and an apparatus for processing video data, so that switching efficiency of media data segments can be improved and user experience of video watching can be enhanced.

A first aspect provides a method for processing video data. The method may include:

parsing media presentation description to obtain flag information, where the flag information is used to identify a first representation of a video, and playing duration of a segment described in the first representation is shorter than playing duration of a segment described in a second representation of the video; obtaining switching instruction information, where the switching instruction information is used to instruct to switch from a current spatial object to a target spatial object; obtaining a target representation based on the flag information and the switching instruction information, where the target representation corresponds to the target spatial object; and obtaining a current playing moment of the video, and obtaining a target representation segment based on the current playing moment and the target representation.

In the embodiments of the present disclosure, the switching instruction information obtained by a client may include information about the foregoing head movements, eye movements, gestures or other physical behavior and actions, or may include input information of the user. The input information may include keyboard input information, voice input information, touchscreen input information, and the like.

In a feasible implementation, the flag information includes at least one of a representation type flag, playing duration of a representation segment, and switching point information.

In the embodiments of the present disclosure, the flag information used to identify the first representation may exist in a plurality of representation forms, so that flexibility is higher and applicability is higher. The representation type flag is used to identify the first representation in the video, so that when a spatial object switching instruction is received, a segment with relatively short playing duration of a target first representation can be preferentially selected for switching, so that switching and playing efficiency of a stream segment can be improved and video content corresponding to a switch-to video spatial region is rapidly presented to the user, thereby enhancing user experience of video watching.

In a feasible implementation, the switching point information is used to identify switching segment information for performing representation switching between the first representation and the second representation, where the switching segment information includes at least one of a segment interval, a segment position of the first representation, and a segment position of the second representation; or

the switching point information is a flag (flag), and the flag is used to indicate a switching capability of a segment.

In a possible manner, when a value of the flag is 1, it indicates that the client can switch from a current segment; or when a value of the flag is 0, it indicates that the client cannot switch from a current segment seamlessly.

In the embodiments of the present disclosure, the switching point information may be used to identify switching segment information for performing content switching between the first representation and the second representation, and the switching segment information may exist in a plurality of representation forms, so that flexibility is higher and applicability is higher.

In a feasible implementation, the flag information is carried in attribute information of a representation set including the first representation carried in the media presentation description.

In a feasible implementation, the flag information is carried in attribute information of the first representation carried in the media presentation description.

In a feasible implementation, the flag information is carried in attribute information of the segment in the first representation carried in the media presentation description.

In the embodiments of the present disclosure, the flag information used to identify the first representation may be carried in the media presentation description in a plurality of representation forms, or may be further carried in attribute information at different positions in the media presentation description, so that flexibility is higher and applicability is higher.

In a feasible implementation, the obtaining a target representation segment based on the current playing moment and the target representation includes:

obtaining segment information of the target representation, where the segment information of the target representation includes playing duration corresponding to segments included in the target representation;

calculating playing start moments of the segments based on the playing duration corresponding to the segments, and determining a first moment based on the playing start moments of the segments and the current playing moment, where the first moment is one of the playing start moments of the segments that is closest to the current playing moment; and

determining a segment whose playing start moment is the first moment as the target representation segment.

In the embodiments of the present disclosure, the playing start moments of the segments may be determined based on the playing duration of the segments included in the target representation, a segment whose playing start moment is closest to the current playing moment in the target representation may be determined as the target segment of video switching based on the current playing moment, and the target segment can be presented at the playing start moment of the target segment, so that it is ensured that played video content is coherent during viewport switching and video content is presented smoothly, thereby enhancing user experience of video watching.

In an implementation of the embodiments of the present disclosure, refer to an example in the foregoing MPD for the media presentation description.

In an implementation of the embodiments of the present disclosure, refer to an example in FIG. 11 for the switching stream.

In an implementation of the embodiments of the present disclosure, the switching instruction information includes information representing a switch-to viewport, and the client may determine information about a viewport stream and the switching stream based on the switching instruction information, where the information is, for example, ID or storage position information of the viewport stream and ID or storage position information of the switching stream.

In an implementation of the embodiments of the present disclosure, the client may obtain, according to the switching instruction information, a spatial object associated with a switch-to target viewport, a target switching stream (or referred to as a target representation) is then determined from a plurality of switching streams based on a spatial object associated with a switch-to target viewport and spatial objects associated with switching streams.

After the target switching stream is determined, a segment to be played (that is, a target representation segment) of the target switching stream may be determined based on the current playing moment, and a corresponding HTTP request is then constructed according to a URL template included in the MPD, to request the corresponding segment in the switching stream.

In an implementation of the embodiments of the present disclosure, a URL of a segment may be constructed based on the current playing moment and information about the target switching stream.

For related manners of constructing a segment URL and requesting a segment, refer to descriptions in the DASH standard or descriptions of other similar manners. Details are not described herein again.

After receiving the segment in the switching stream, the client may directly present the segment.

In an implementation of the embodiments of the present disclosure, the client further needs to switch from the switching stream to a viewport stream corresponding to a switch-to viewport, thereby ensuring desirable experience of the user.

In an embodiment of another aspect of the embodiments of the present disclosure, a syntax element description of the switching point information is further added to the MPD.

In the embodiments of the present disclosure, a method for switching from a switching stream to a viewport stream is described. Because switching is not performed between the switching stream and the viewport stream at each segment, the embodiments of the present disclosure provide a method for describing a switching point. In an on-demand application scenario, description information is stored in a media data file, and in a live application scenario, description information is stored in an MPD. The two manners are compatible with the existing DASH protocol, make fewest changes to an existing CDN and a client, and support switching between a switching stream and a viewport stream.

The switching point information between the viewport stream (that is, a non-switching stream) and the switching stream is described in a file. Specific syntax is as follows:

aligned(8) class SegmentIndexBox extends FullBox(‘sidx’,
version, flag) {

unsigned int(32) reference_ID;
unsigned int(32) timescale;
if (version==0) {

unsigned int(32) earliest_presentation_time;
unsigned int(32) first_offset;
}
else {
unsigned int(64) earliest_presentation_time;
unsigned int(64) first_offset;
}

unsigned int(16) reserved = 0;
unsigned int(16) reference_count;
for(i=1; i <= reference_count; i++)
{

| bit (1) reference_type; | |
|---|---|
| unsigned int(31) referenced_size; | |
| unsigned int(32) subsegment_duration; | |
| bit(1) starts_with_SAP; | |
| unsigned int(3) SAP_type; | |
| unsigned int(28) SAP_delta_time; | |
| unsigned int(8) | FOV_group_change_Info; |

}

}

In a possible embodiment, a value of the flag in a sidx box is 1, and it may indicate that the sidx box includes the switching point information or may represent switching information of each segment.

FOV_group_change_Info: The information identifies related information about switching between a current segment and another representation having an attribute duration/FOVGroup/FovType.

The information may indicate whether switching can be performed between a current segment and another duration/FOVGroup/FovType stream. For example, corresponding to MPD samples 1 to 3 in the foregoing embodiments, a stream file video-3.mp4 whose representation id is equal to “3” includes the foregoing sidx box. It is obtained by parsing the box that FOV_group_change_Info of a segment is equal to 1, and it indicates that the client can switch from the segment to a representation whose representation id is equal to “2”, and otherwise, switching cannot be performed. For the MPD sample 4 in Embodiment 1, if FOV_group_change_Info is equal to 1, it may indicate that the client can switch from the current segment to a representation whose attribute FOVGroup is equal to 1.

The information may be alternatively a value of a segment ID of another duration/FOVGroup/FovType stream to which the client can switch from a current segment. For example, if FOV_group_change_Info is equal to 4, it indicates that the client can switch from the current segment to a fourth segment in a viewport stream.

The switching point information between the viewport stream and the switching stream is described in the MPD. Specific syntax is shown in the following Table 4, and is represented as another syntax information table:

TABLE 4

| Parameters | Use | Description |
|---|---|---|
| FOV_group_change_Info | O | Describe indication information of a |
| | | switching point between a viewport |
| | | stream and a switching stream. |

Legend:
M = Mandatory,
O = Optional

MPD Sample 5:

<?xml version=“1.0” encoding=“UTF-8”?>

<MPD

xmlns:xsi=“http://www.w3.org/2001/XMLSchema-instance”
xmlns=“urn:mpeg:dash:schema:mpd:2011”
xsi:schemaLocation=“urn:mpeg:dash:schema:mpd:2011 DASH-MPD.xsd”
[...]>
<Period>

<AdaptationSet [...]>

<SupplementalProperty schemeIdUri=“urn:mpeg:dash:srd:2014”

value=“1, 0, 0, 1920, 1080, 1920, 1080, 1”/>

<Representation id=“1” bandwidth=“1000000” >

<BaseURL>video-1.mp4</BaseURL>

</Representation>

</AdaptationSet>
<AdaptationSet [...]>

<EssentialProperty schemeIdUri=“urn:mpeg:dash:srd:2014”

value=“1, 0, 0, 1920, 1080, 3840, 2160, 2”/>

<!--Viewport stream-->

```
  <Representation id=“2” bandwidth=“450000”>
  < SegmentList >
  <SegmentURL media=“seg-m1-1.mp4”/>
  <SegmentURL media=“seg-m1-2.mp4”/>
```

</ SegmentList >

```
  </Representation>
<!--Switching stream-->
  <Representation id=“3” bandwidth=“4500000” fovType=“1”>
```

< SegmentList >

<SegmentURL media=“seg-m1-1.mp4”/>
<SegmentURL media=“seg-m1-2.mp4”/>
<SegmentURL media=“seg-m1-3.mp4” FOV_group_change_Info=“2” />

</ SegmentList >

</Representation>

</AdaptationSet>

</Period>

</MPD>

In the MPD sample, a stream whose representation id is equal to “3” is a switching stream, the client can switch to a viewport stream when SegmentURL media is equal to “seg-m1-3.mp4”, and the client can switch to a second segment in the viewport stream.

In an implementation of this embodiment of the present disclosure, the information FOV_group_change_Info is added to an existing sidx box. The information may be alternatively added to another box, for example:

aligned(8) class SegmentIndexSwitchBox extends FullBox(‘sids’, version, flag) {

unsigned int(16) reference_count;

for(i=1; i <= reference count; i++)
{

| | |
|---|---|
| unsigned int(8) | FOV_group_change_Info; |

}

}

Semantics of FOV_group_change_Info are the same as semantics in the foregoing embodiments.

In an implementation of this embodiment of the present disclosure, the client may implement switching from a switching stream to a viewport stream in the following manners.

The client obtains an index segment (index segment) in the switching stream, and parses sidx information to obtain information about a segment switching point (FOV_group_change_Info).

When the client detects switching point information of a segment, it indicates that the client can switch from the current segment to a segment in a viewport stream. The client finds, in the viewport stream based on FOV_group_change_Info/playing start time information of the current segment, information about a segment to which the client can switch from the current segment, and constructs a URL of the segment in the viewport stream. As shown in FIG. 11, the client detects FOV_group_change_Info information of the fifth segment in a viewport switching stream the rep A′, and determines that the client can switch to the rep A at the fifth segment. The client finds, in the rep A based on a playing start time of the fifth segment in the rep A′, a segment (the second segment in the rep A) whose start time is closest to the playing start time of the fifth segment in the rep A′, and constructs a URL of the segment. The client requests the segment in the viewport stream based on the constructed URL of the viewport stream.

A second aspect provides a client. The client may include:

an obtaining module, configured to parse media presentation description to obtain flag information, where the flag information is used to identify a first representation of a video, and playing duration of a segment described in the first representation is shorter than playing duration of a segment described in a second representation of the video;

a receiving module, configured to obtain switching instruction information, where the switching instruction information is used to instruct to switch from a current spatial object to a target spatial object; and

a determining module, configured to obtain a target representation based on the flag information obtained by the obtaining module and the switching instruction information received by the receiving module, where the target representation corresponds to the target spatial object, where

the obtaining module is further configured to: obtain a current playing moment of the video, and obtain a target representation segment based on the current playing moment and the target representation determined by the determining module.

In a feasible implementation, the flag information includes at least one of a representation type flag, playing duration of a representation segment, and switching point information.

In a feasible implementation, the switching point information is used to identify switching segment information for performing representation switching between the first representation and the second representation, where

the switching segment information includes at least one of a segment interval, a segment position of the first representation, and a segment position of the second representation; or

the switching point information is a flag (flag), and the flag is used to indicate a switching capability of a segment.

In a possible manner, when a value of the flag is 1, it indicates that the client can switch from a current segment; or when a value of the flag is 0, it indicates that the client cannot switch from a current segment seamlessly.

In a feasible implementation, the flag information is carried in attribute information of a representation set including the first representation carried in the media presentation description.

In a feasible implementation, the flag information is carried in attribute information of the first representation carried in the media presentation description.

In a feasible implementation, the flag information is carried in attribute information of the segment in the first representation carried in the media presentation description.

In a feasible implementation, the obtaining module is configured to:

obtain segment information of the target representation, where the segment information of the target representation includes playing duration corresponding to segments included in the target representation;

calculate playing start moments of the segments based on the playing duration corresponding to the segments, and determine a first moment based on the playing start moments of the segments and the current playing moment, where the first moment is one of the playing start moments of the segments that is closest to the current playing moment; and

determine a segment whose playing start moment is the first moment as the target representation segment.

A third aspect provides a method for processing video data. The method may include:

generating, by a server, a first representation of a video based on an encoding configuration parameter of the first representation, and generating a second representation of the video based on an encoding configuration parameter of the second representation, where playing duration of a segment described in the first representation is shorter than playing duration of a segment described in the second representation; and

generating, by the server, a media presentation description, where the media presentation description includes flag information, and the flag information is used to identify the first representation of the video.

In a feasible implementation, the flag information describes the playing duration of the segment in the first representation and the playing duration of the segment in the second representation, where

the playing duration of the segment in the first representation is shorter than the playing duration of the segment in the second representation of the video.

In a feasible implementation, the flag information describes switching point information of the segments in the first representation and the second representation.

In a feasible implementation, the switching point information is used to identify switching segment information for performing content switching between the first representation and the second representation, where

the switching segment information includes at least one of a segment interval, a segment position of the first representation, and a segment position of the second representation; or

the switching point information is a flag (flag), and the flag is used to indicate a switching capability of a segment.

In a possible manner, when a value of the flag is 1, it indicates the client can switch from a current segment; or when a value of the flag is 0, it indicates that the client cannot switch from a current segment seamlessly.

A fourth aspect provides a server. The server may include:

a generation module, configured to: generate a first representation of a video based on an encoding configuration parameter of the first representation, and generate a second representation of the video based on an encoding configuration parameter of the second representation, where playing duration of a segment described in the first representation is shorter than playing duration of a segment described in the second representation; and

a description module, configured to generate a media presentation description, where the media presentation description includes flag information, and the flag information is used to identify the first representation of the video.

In a feasible implementation, the flag information describes the playing duration of the segment in the first representation and the playing duration of the segment in the second representation, where

the playing duration of the segment in the first representation is shorter than the playing duration of the segment in the second representation of the video.

In a feasible implementation, the flag information describes switching point information of the segments in the first representation and the second representation.

In a feasible implementation, the switching point information is used to identify switching segment information for performing content switching between the first representation and the second representation, where

the switching segment information includes at least one of a segment interval, a segment position of the first representation, and a segment position of the second representation; or

the switching point information is a flag (flag), and the flag is used to indicate a switching capability of a segment.

In a possible manner, when a value of the flag is 1, it indicates the client can switch from a current segment; or when a value of the flag is 0, it indicates that the client cannot switch from a current segment seamlessly.

A fifth aspect provides a method for processing dynamic adaptive streaming over HTTP video data. The method may include:

receiving a media presentation description, where the media presentation description includes at least two representations, the representation includes attribute information describing a media data segment, the media presentation description further includes at least two switching stream representations, and the switching stream representation includes attribute information describing a data segment in a switching stream, where

spatial objects associated with the at least two representations are in a one-to-one correspondence with spatial objects associated with the at least two switching stream representations, and playing duration corresponding to a media data segment described in a media representation is longer than playing duration corresponding to a data segment in a switching stream described in a switching stream representation corresponding to the media representation;

obtaining switching instruction information;

obtaining a target switching stream representation according to the switching instruction information and the media presentation description, where the target viewport switching stream representation is one of the at least two switching stream representations; and

obtaining target switching stream request information based on the target switching stream representation, where the switching stream request information is used to request some data segments in a target switching stream.

In a feasible implementation, the media presentation description further includes spatial information of a spatial object associated with a switching stream representation, and the spatial information is used to describe a spatial relationship between the spatial object associated with the switching stream representation and a content component associated with the switching stream representation;

the obtaining a target switching stream representation according to the switching instruction information and the media presentation description includes:

obtaining spatial information of a target spatial object according to the switching instruction information; and

obtaining the target switching stream representation according to the spatial information of the target spatial object and the spatial relationship.

In a feasible implementation, the media presentation description includes information about an adaptation set, and the adaptation set is used to describe a data set of attributes of media data segments of a plurality of interchangeable encoded versions of a same media content component, where

the information about the adaptation set includes information about the at least two switching stream representations.

In a feasible implementation, the media presentation description includes information about a representation, and the representation is a collection and an encapsulation of one or more streams in a delivery format, where

the information about the representation includes information about the at least two switching stream representations.

In a feasible implementation, the information about the switching stream representation includes at least one of a stream type flag, playing duration of a stream segment, and switching point information.

In a feasible implementation, the switching point information is used to identify switching segment information for performing content switching between a switching stream and a non-switching stream, where

the switching segment information includes at least one of a stream segment interval, a stream segment position of a switching stream, and a stream segment position of a non-switching stream; or

the switching point information is a flag (flag), and the flag is used to indicate a switching capability of a segment.

In a possible manner, when a value of the flag is 1, it indicates the client can switch from a current segment; or when a value of the flag is 0, it indicates that the client cannot switch from a current segment seamlessly.

A sixth aspect provides a client. The client may include:

a receiving module, configured to receive a media presentation description, where the media presentation description includes at least two representations, the representation includes attribute information describing a media data segment, the media presentation description further includes at least two switching stream representations, and the switching stream representation includes attribute information describing a data segment in a switching stream, where spatial objects associated with the at least two representations are in a one-to-one correspondence with spatial objects associated with the at least two switching stream representations, and playing duration corresponding to a media data segment described in a media representation is longer than playing duration corresponding to a data segment in a switching stream described in a switching stream representation corresponding to the media representation; and

an obtaining module, configured to obtain switching instruction information, where

the obtaining module is further configured to obtain a target switching stream representation according to the switching instruction information and the media presentation description, where the target viewport switching stream representation is one of the at least two switching stream representations; and

the obtaining module is further configured to obtain target switching stream request information based on the target switching stream representation, where the switching stream request information is used to request some data segments in a target switching stream.

In a feasible implementation, the media presentation description further includes spatial information of a spatial object associated with a switching stream representation, and the spatial information is used to describe a spatial relationship between the spatial object associated with the switching stream representation and a content component associated with the switching stream representation; and

the obtaining module is configured to:

obtain spatial information of a target spatial object according to the switching instruction information; and

obtain the target switching stream representation according to the spatial information of the target spatial object and the spatial relationship.

In a feasible implementation, the media presentation description includes information about an adaptation set, and the adaptation set is used to describe a data set of attributes of media data segments of a plurality of interchangeable encoded versions of a same media content component, where the information about the adaptation set includes information about the at least two switching stream representations.

In a feasible implementation, the media presentation description includes information about a representation, and the representation is a collection and an encapsulation of one or more streams in a delivery format, where

the information about the representation includes information about the at least two switching stream representations.

In a feasible implementation, the information about the switching stream representation includes at least one of a stream type flag, playing duration of a stream segment, and switching point information.

In a feasible implementation, the switching point information is used to identify switching segment information for performing content switching between a switching stream and a non-switching stream, where

the switching segment information includes at least one of a stream segment interval, a stream segment position of a switching stream, and a stream segment position of a non-switching stream; or

the switching point information is a flag (flag), and the flag is used to indicate a switching capability of a segment.

In a possible manner, when a value of the flag is 1, it indicates the client can switch from a current segment; or when a value of the flag is 0, it indicates that the client cannot switch from a current segment seamlessly.

A seventh aspect provides a method for processing dynamic adaptive streaming over HTTP video data. The method may include:

receiving a media presentation description, where the media presentation description includes information about at least two representations, the representation includes at least one segment, and segment duration of a first representation of the at least two representations is shorter than segment duration of a second representation of the at least two representations, where

a spatial object associated with the first representation corresponds to a spatial object associated with the second representation;

obtaining switching instruction information; and

obtaining, according to the representation switching instruction, the segment in the first representation, and obtaining the segment in the second representation after a preset time.

In a feasible implementation, the first representation carries switching point information.

In a feasible implementation, the media presentation description carries flag information, where

the flag information includes at least one of a representation type flag, playing duration of a representation segment, and switching point information.

In a feasible implementation, the switching point information is used to identify switching segment information for performing representation switching between a first stream and a second stream, where

the switching segment information includes at least one of a segment interval, a segment position of the first representation, and a segment position of the second representation; or

the switching point information is a flag (flag), and the flag is used to indicate a switching capability of a segment.

In a possible manner, when a value of the flag is 1, it indicates the client can switch from a current segment; or when a value of the flag is 0, it indicates that the client cannot switch from a current segment seamlessly.

In a feasible implementation, the carried switching point information is carried in a specified box in the first representation.

In a feasible implementation, the specified box is a sidx box included in the first representation, and the sidx box is used to describe segment information.

In a feasible implementation, the representation type flag is used to identify the first representation.

In a feasible implementation, the media presentation description includes information about an adaptation set, and the adaptation set is used to describe a data set of attributes of media data segments of a plurality of interchangeable encoded versions of a same media content component, where

the information about the adaptation set includes the flag information.

In a feasible implementation, the media presentation description includes information about a representation, and the representation is a collection and an encapsulation of one or more streams in a delivery format, where

the information about the representation includes the flag information.

In a feasible implementation, the media presentation description includes information about a descriptor, and the descriptor is used to describe spatial information of the associated spatial objects, where

the information about the descriptor includes the flag information.

An eighth aspect provides a client. The client may include:

a receiving module, configured to receive a media presentation description, where the media presentation description includes information about at least two representations, the representation includes at least one segment, and segment duration of a first representation of the at least two representations is shorter than segment duration of a second representation of the at least two representations, where a spatial object associated with the first representation corresponds to a spatial object associated with the second representation; and

an obtaining module, configured to obtain switching instruction information, where

the obtaining module is further configured to: obtain, according to the representation switching instruction, the segment in the first representation, and obtain the segment in the second representation after a preset time.

In a feasible implementation, the first representation carries switching point information.

In a feasible implementation, the media presentation description carries flag information, where

the flag information includes at least one of a representation type flag, playing duration of a representation segment, and switching point information.

In a feasible implementation, the switching point information is used to identify switching segment information for performing representation switching between a first stream and a second stream, where

the switching segment information includes at least one of a segment interval, a segment position of the first representation, and a segment position of the second representation; or

the switching point information is a flag (flag), and the flag is used to indicate a switching capability of a segment.

In a possible manner, when a value of the flag is 1, it indicates the client can switch from a current segment; or when a value of the flag is 0, it indicates that the client cannot switch from a current segment seamlessly.

In a feasible implementation, the carried switching point information is carried in a specified box in the first representation.

In a feasible implementation, the specified box is a sidx box included in the first representation, and the sidx box is used to describe segment information.

In a feasible implementation, the representation type flag is used to identify the first representation.

In a feasible implementation, the media presentation description includes information about an adaptation set, and the adaptation set is used to describe a data set of attributes of media data segments of a plurality of interchangeable encoded versions of a same media content component, where

the information about the adaptation set includes the flag information.

In a feasible implementation, the media presentation description includes information about a representation, and the representation is a collection and an encapsulation of one or more streams in a delivery format, where

the information about the representation includes the flag information.

In a feasible implementation, the media presentation description includes information about a descriptor, and the descriptor is used to describe spatial information of the associated spatial objects, where

the information about the descriptor includes the flag information.

In the embodiments of the present disclosure, the switching stream and the viewport stream included in the video may be identified based on the flag information carried in the media presentation description. During switching between spatial objects, the target switching stream corresponding to the target spatial object may be identified from the plurality of switching streams of the video based on the target spatial object, the target segment in the target switching stream can be determined based on the video playing moment during spatial object switching, and the target segment is presented. The playing duration of the segment in the switching stream is shorter than the playing duration of the segment in the viewport stream. Therefore, during spatial object switching, the client can first switch to a switching stream segment having relatively short playing duration, so that switching and playing efficiency of segments corresponding to spatial objects can be improved, and user experience can be enhanced. Further, the segment in the target viewport stream corresponding to the target spatial object can be obtained and presented, to complete switching and playing of a segment in a corresponding viewport stream during spatial object switching. After completing intermediate transition of stream switching of a spatial object by using the target switching stream, the client may switch to playing of the target viewport stream, so that stability of video playing after spatial object switching can be ensured, and user experience of video watching can be enhanced.

### BRIEF DESCRIPTION OF DRAWINGS

To describe the technical solutions in the embodiments of the present disclosure more clearly, the following briefly describes the accompanying drawings required for describing the embodiments.

FIG. 1 is a schematic diagram of an example of a framework of DASH standard transmission used in system-layer video streaming media transmission;

FIG. 2 is a schematic structural diagram of an MPD of DASH standard transmission used in system-layer video streaming media transmission;

FIG. 3 is a schematic diagram of switching between stream segments according to an embodiment of the present disclosure;

FIG. 4 is a schematic diagram of a segment storage manner in stream data;

FIG. 5 is another schematic diagram of a segment storage manner in stream data;

FIG. 6 is a schematic diagram of a spatial relationship among spatial objects;

FIG. 7 is a schematic diagram of a spatial object change corresponding to a viewport change;

FIG. 8 is a schematic flowchart of a method for processing video data according to an embodiment of the present disclosure;

FIG. 9 is a schematic diagram of a spatial object according to an embodiment of the present disclosure;

FIG. 10 is a schematic diagram of segments in a DASH stream;

FIG. 11 is another schematic diagram of segments in a DASH stream;

FIG. 12 is another schematic diagram of a spatial object change corresponding to a viewport change;

FIG. 13 is a schematic structural diagram of a client according to an embodiment of the present disclosure;

FIG. 14 is a schematic structural diagram of a server according to an embodiment of the present disclosure;

FIG. 15 is another schematic structural diagram of a client according to an embodiment of the present disclosure; and

FIG. 16 is another schematic structural diagram of a client according to an embodiment of the present disclosure.

### DESCRIPTION OF EMBODIMENTS

The following clearly describes the technical solutions in the embodiments of the present disclosure with reference to the accompanying drawings in the embodiments of the present disclosure.

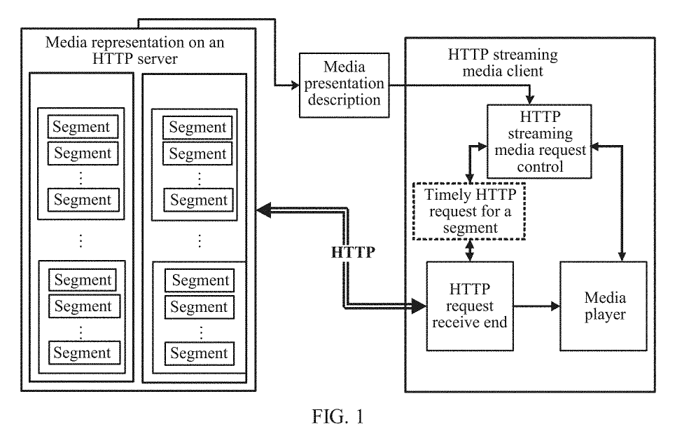

Currently, a client-oriented solution of system-layer video streaming media transmission may use a DASH standard framework. FIG. 1 is a schematic diagram of an example of a DASH standard-compliant transmission framework used in system-layer video streaming media transmission. A data transmission process in the solution of system-layer video streaming media transmission includes two processes: a process in which a server (for example, an HTTP server, and a media content preparation server, and referred to as a server for short hereinafter) generates media data for video content, and a process in which a client (for example, an HTTP streaming media client) requests and obtains the media data from the server to respond to a request of the client. The media data includes a media presentation description (Media Presentation Description, MPD) file and a media stream. The MPD on the server includes a plurality of representations (representation), and each representation describes a plurality of segments. An HTTP streaming media request control module of the client obtains the MPD sent by the server, and analyzes the MPD to determine information about segments in a video stream described in the MPD, so that segments to be requested can be determined. An HTTP request receive end requests a corresponding segment from the server, and a media player decodes and plays the segment.

(1) In the foregoing process in which the server generates media data for video content, the media data generated by the server for the video content includes video streams that correspond to same video content and that have different video quality, and an MPD file of the video streams. For example, the server generates a stream having a low resolution, a low bitrate, and a low frame rate (for example, a resolution of 360p, a bitrate of 300 kbps, and a frame rate of 15 fps), a stream having an intermediate resolution, an intermediate bitrate, and a high frame rate (for example, a resolution of 720p, a bitrate of 1200 kbps, and a frame rate of 25 fps), a stream having a high resolution, a high bitrate, and a high frame rate (for example, a resolution of 1080p, a bitrate of 3000 kbps, and a frame rate of 25 fps), and the like for video content of a same episode of TV show.

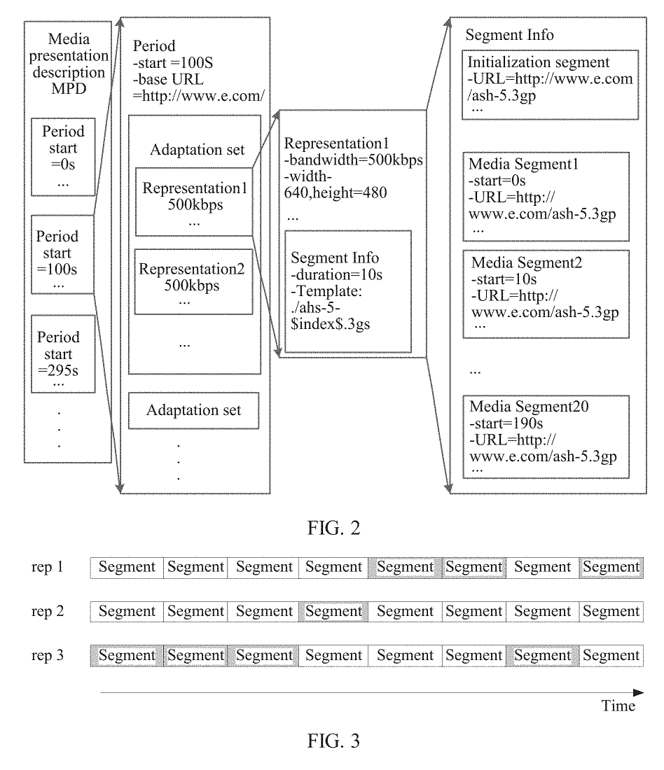

In addition, the server further generates an MPD file for the video content of the episode of TV show. FIG. 2 is a schematic structural diagram of an MPD of the DASH standard of a system transmission solution. The MPD of the stream includes a plurality of periods (Period). For example, a part of a period whose period start is equal to 100 s in the MPD of FIG. 2 may include a plurality of adaptation sets (adaptation set). Each adaptation set may include a plurality of representations such as a representation 1, a representation 2, . . . , and the like. Each representation describes one or more segments in the stream.

In an embodiment of the present disclosure, each representation describes, in a time order, information about several segments (Segment) such as an initialization segment (Initialization segment), a media segment (Media Segment) 1, a Media Segment 2, . . . , and a Media Segment 20. The representation may include segment information such as a playing start moment, playing duration, a network storage address (for example, a network storage address represented in a form of a Uniform Resource Locator (Universal Resource Locator, URL)).

(2) In the process in which the client requests and obtains media data from the server, when the user selects to play a video, the client obtains a corresponding MPD from the server based on video content demanded by the user. The client sends, to the server based on a network storage address of a stream segment described in the MPD, a request of downloading the stream segment corresponding to the network storage address. The server sends the stream segment to the client based on the received request. After obtaining the stream segment sent by the server, the client may perform an operation such as decoding and playing by using the media player.

The solution of system-layer video streaming media transmission uses the DASH standard, and transmits video data in a manner in which the client analyzes an MPD, requests video data from the server on demand, and receives data sent by the server.

FIG. 3 is a schematic diagram of switching between stream segments according to an embodiment of the present disclosure. A server may prepare three pieces of stream data having different video quality for same video content (for example, a movie), and use three representations in an MPD to describe the three pieces of stream data having different video quality. The three representations (referred to as a rep for short hereinafter) may be assumed as a rep 1, a rep 2, and a rep 3. The rep 1 is a high-resolution video whose bitrate is 4 mbps (megabits per second), the rep 2 is a standard-resolution video whose bitrate is 2 mbps, and the rep 3 is a normal video whose bitrate is 1 mbps. A segment in each rep includes video streams in a time period. In a same time period, segments included in different reps are aligned with each other. each rep describes a segment in each time period in a time order, and segments in a same time period have the same length, so that switching between content of segments in different reps can be implemented. As shown in the figure, shaded segments in the figure are segment data that a client requests to play. The first three segments requested by the client are segments in the rep 3. When requesting the fourth segment, the client may request the fourth segment in the rep 2, so that when playing of the third segment in the rep 3 is implemented, the client switches to the fourth segment in the rep 2 for playing. A playing termination point (which may correspondingly be a playing end moment in terms of time) of the third segment in the rep 3 is a playing start point (which may correspondingly be a playing start moment in terms of time) of the fourth segment, and is also a playing start point of the fourth segment in the rep 2 or the rep 1, to implement alignment of segments in different reps. After requesting the fourth segment in the rep 2, the client switches to the rep 1 to request the fifth segment and the sixth segment in the rep 1. Subsequently, the client may switch to the rep 3 to request the seventh segment in the rep 3, and then switches to the rep 1 to request the eighth segment in the rep 1.

It should be noted that in an existing DASH stream, for switching between segments in different reps, playing of a segment (for example, the third segment in the rep 3 in FIG. 3, and is marked as a segment 3) in a last rep needs to be implemented before the client can switch to a specified segment (for example, the fourth segment in the rep 2 in FIG. 3, and is marked as the segment 4) in a next rep, and video content of the segment 3 and the segment 4 needs to be contiguous in a time domain. the playing end moment of segment 3 is the playing start moment of the segment 4, and the video content of the segment 3 and the segment 4 is contiguous.

The segments in the reps may be connected head to tail and stored in one file or may be independently stored in individual small files. The segment may be encapsulated according to a format (ISO BMFF (Base Media File Format)) in the standard ISO/IEC 14496-12 or may be encapsulated according to a format (MPEG-2 TS) in the ISO/IEC 13818-1. A format may be determined according to a requirement in an actual application scenario and is not limited herein.

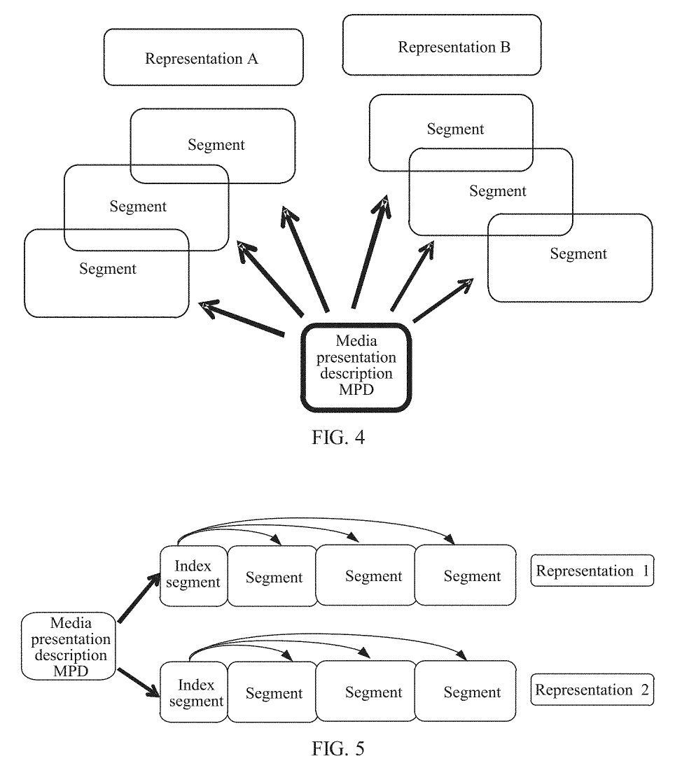

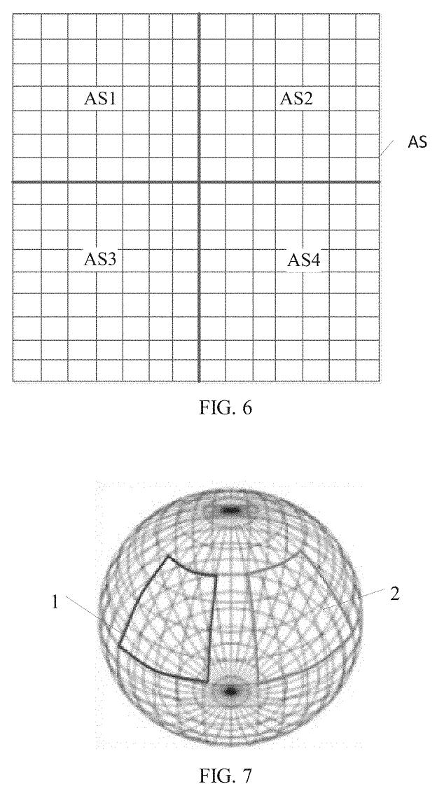

It is mentioned in the DASH media file format that the segments are stored in two manners. In one manner, the segments are stored independently. FIG. 4 is a schematic diagram of a segment storage manner in stream data. In the other manner, all segments in a same rep are stored in one file. FIG. 5 is another schematic diagram of a segment storage manner in stream data. As shown in FIG. 4, each segment in the rep A is stored separately in a file, and each segment in the rep B is also stored separately in a file. Correspondingly, in the storage manner shown in FIG. 4, the server may describe information such as URLs of the segments in the MPD of the streams in a template form or a list form. As shown in FIG. 5, all the segments in the rep 1 are stored in a file, and all the segments in the rep 2 are stored in a file. Correspondingly, by using the storage method shown in FIG. 5, the server may use an index segment (index segment, that is, sidx in FIG. 5) in the MPD of the streams to describe related information of each segment. The index segment describes information such as a byte offset of each segment in a file in which the segment is stored, a size of each segment, and duration (the duration is alternatively referred to as playing duration of each segment, and is referred to as duration for short) of each segment.

Currently, as applications for watching VR videos such as 360-degree videos become increasingly popular, an increasingly large quantity of users start to experience large viewport VR videos. Such new video watching applications provide user with new video watching modes and visual experience and pose new technical challenges. During watching of a video having a large viewport such as a 360-degree viewport (the 360-degree viewport is used as an example for description), a presentation space of the VR video is a 360-degree space that exceeds a normal visual range of human eyes. Therefore, when watching the video, a user may change a watching angle (that is, a viewport, FOV) at any time. A video image that the user sees changes as a watching viewport of the user changes. Therefore, played content of the video needs to change as the viewport of the user changes. FIG. 7 is a schematic diagram of a spatial object change corresponding to a viewport change. A box 1 and a box 2 are spatial objects corresponding to two different fields of view of the user. Different spatial objects display different segments in a video stream. When watching the video, the user may make an eye movement or a head movement or perform an operation such as picture switching of a video watching device to switch a viewport of watching the video from the box 1 to the box 2. When the viewport of the user is the box 1, the watch video image is a video image presented by content included in a segment in the video stream. At a next moment, the viewport of the user is switched to the box 2. At this time, a video image that the user watches should be switched to a video image presented by the spatial object corresponding to the box 2 at the moment. In this case, the video image is a video image presented by content included in another segment. To enable the user to see a switch-to video image rapidly, the client needs to implement fast and desirable playing and switching between the segments in the video stream. For video stream segment switching induced by viewport switching, the method and apparatus for processing video data provided in this embodiment of the present disclosure can provide a switching manner that has higher efficiency and better visual experience.

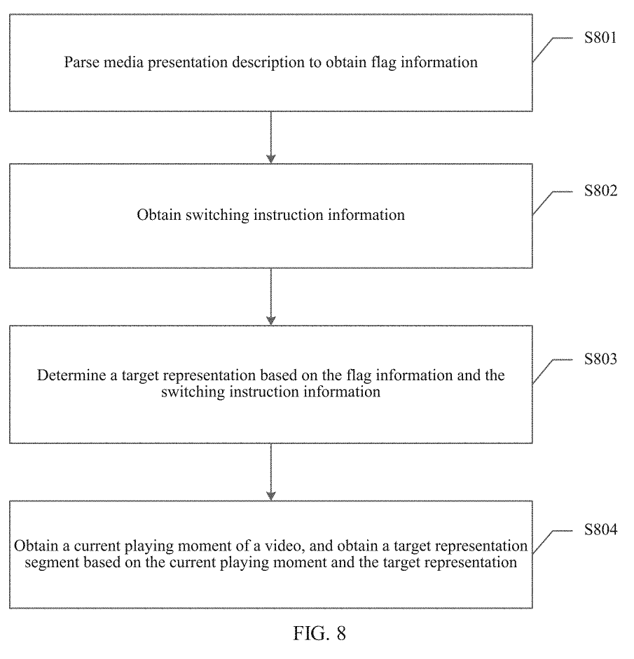

The method and apparatus for processing video data provided in the embodiments of the present disclosure are described below with reference to FIG. 8 to FIG. 16.

FIG. 8 is a schematic flowchart of a method for processing video data according to an embodiment of the present disclosure. The method provided in this embodiment of the present disclosure include the following steps.

S801: Parse a media presentation description to obtain flag information.

In some feasible implementations, for output of a 360-degree large viewport video image, a server may divide a space in a 360-degree viewport range to obtain a plurality of spatial objects. Each spatial object corresponds to a sub-viewport of a user, and is, for example, a spatial object 1 corresponding to a box 1 and a spatial object 1 corresponding to a box 2 in FIG. 7. Further, the server may prepare a group of video streams for each spatial object. the server may obtain encoding configuration parameter of each stream in a video, and generates the stream corresponding to each spatial object of the video based on the encoding configuration parameter of the stream. A client may request a video segment corresponding to a sub-viewport in a time period from the server during output of the video and output the video segment to a spatial object corresponding to the viewport. The client outputs, in a same time period, video segments corresponding to all sub-fields of view in the 360-degree viewport range, so that a complete video image in the time period can be output and displayed in the entire 360-degree space.

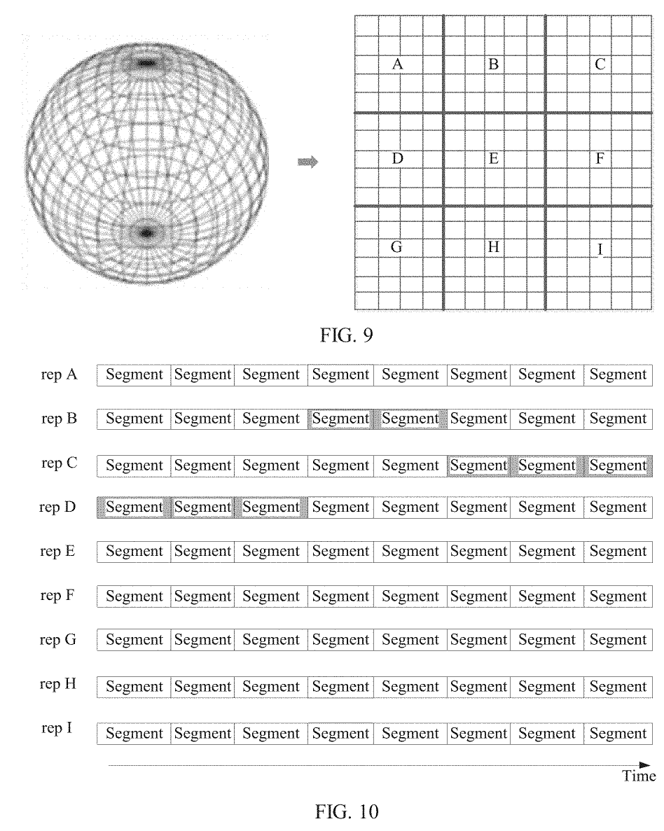

In a implementation, in the division of the 360-degree space, the client may first map a spherical surface into a plane, and divide the space in the plane. the client may map the spherical surface into a latitude-longitude plan in a manner of latitude-longitude mapping. FIG. 9 is a schematic diagram of a spatial object according to an embodiment of the present disclosure. The client may map the spherical surface into the latitude-longitude plan, and divide the latitude-longitude plan into a plurality of spatial objects A to I. Further, the client may alternatively map the spherical surface into a cube, and then unfold a plurality of surfaces of the cube to obtain a plan, or map the spherical surface into another polyhedron, and unfold a plurality of surfaces of the polyhedron to obtain a plan. The client may further map the spherical surface into a plane in other mapping manners, and a mapping manner may be determined according to a requirement in an actual application scenario and is not limited herein. The description is provided below by using the manner of latitude-longitude mapping and with reference to FIG. 9.

As shown in FIG. 9, after the client divides the space of the spherical surface into a plurality of spatial objects A to I, the server may prepare a group of DASH streams for each spatial object. Each spatial object corresponds to a sub-viewport. A group of DASH streams corresponding to each spatial object are viewport streams of each sub-viewport. The viewport streams of each sub-viewport are a part of an entire video stream. Viewport streams of all sub-fields of view form a complete video stream. That is, in a implementation, a group of DASH streams corresponding to each spatial object are all viewport streams. An entire video may be divided into a plurality of viewport streams. a viewport stream corresponding to a spatial object (set as a specified spatial object) may be referred to as a specified viewport stream. During playing of the video, a DASH stream corresponding to one or more corresponding spatial objects may be selected based on a current viewport used by a user to watch the video for playing. When the user switches fields of view used by the user to watch the video, the client may determine, based on a new viewport selected by the user, a DASH stream corresponding to a target spatial object (or referred to as a target viewport stream) of switching, so that video playing content can be switched to the DASH stream corresponding to the target spatial object. FIG. 10 is a schematic diagram of a segment in a DASH stream.

10 viewport streams of a rep A to a rep I in FIG. 10 correspond respectively to the nine spatial objects A to I in the latitude-longitude view. The rep A is any one in the group of DASH streams corresponding to the spatial object A. In this embodiment of the present disclosure, the rep A is used as an example for description. Similarly, a sub-viewport stream in each of the rep B to the rep I is respectively any one in a group of DASH streams corresponding to a spatial object corresponding to each of the rep B to the rep I. In this embodiment of the present disclosure, the rep B, the rep C, and the rep I are used as an example for description. Segments included in viewport streams of each sub-viewport are aligned. segments included in viewport streams in a same time period have the same length. Segments in different viewport streams are aligned, so that for the different viewport streams, seamless switching between video content of segments may be implemented as fields of view are switched. For example, the user switches to the fourth segment in the rep B after playing of the third segment in the rep D is implemented, and subsequently switches to the sixth segment in the rep C after playing of the fifth segment in the rep B is implemented. A video image presented by the client is switched from a picture of a field D of view to a picture of a field B of view, and is then switched to a picture of a field C of view.

It should be noted that in the switching manner of viewport streams shown in FIG. 10, if the client just starts to play the third segment in the rep D and the duration of the third segment is 5 seconds, the user switches the viewport from the field D of view to the field B of view. At this time, the client needs to wait till playing of the third segment is implemented before the client can switch to the fourth segment in the rep B. Therefore, the user needs to wait 5 s before the user can see a video image in the field B of view. For user experience in watching of the VR video, the duration of 5 s makes the user feel discomfort. Generally, the user feels discomfort when such latency exceeds 200 ms. To resolve a discomfort problem of the user, if duration of a segment in a viewport stream is simply shortened to, for example, 200 ms, although a presentation time of a video image of a new viewport during viewport switching is shortened, compression performance of a video is severely affected. With a same target bitrate, video quality of a segment whose duration is 200 ms is much poorer than that of a segment whose duration is 5 s. A larger transmission bandwidth or higher compression performance is required to ensure video quality. Consequently, video stream data needs to meet a higher transmission bandwidth requirement and a higher compression performance requirement, and video output costs of viewport switching are increased.

This embodiment of the present disclosure provides a switching stream (set as a first representation or a switching stream representation) whose segment duration is different from that of a viewport stream, and duration of a segment included in a switching stream is shorter than duration of a segment included in a viewport stream corresponding to the switching stream. Each group of switching streams corresponds to one group of viewport streams, one group of switching streams includes one or more switching streams, and each group of switching streams corresponds to one spatial object. A switching stream and a viewport stream corresponding to the switching stream are associated with a same spatial object. stream segments in a same time period included in a switching stream and a viewport stream corresponding to the switching stream have the same video content.

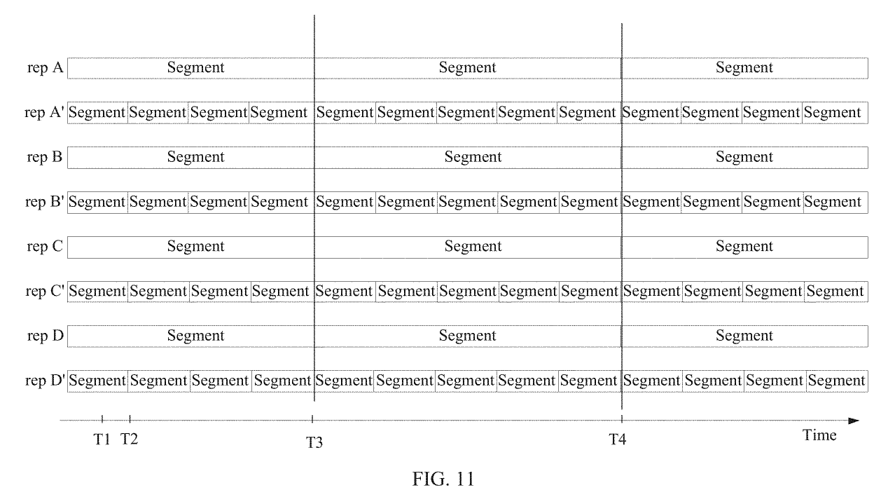

In some feasible implementations, while preparing a viewport stream for video stream data, the server additionally prepares a group of switching streams for each viewport. each group of viewport streams corresponds to a group of switching streams. Each group of viewport streams and switching streams corresponding to the viewport streams include the same sub-viewport (that is, the same spatial object), and a difference is only that a segment in a viewport stream has relatively long duration and a segment in a switching stream has relatively short duration. The server may obtain an encoding configuration parameter (set as a second encoding configuration parameter) of a viewport stream and an encoding configuration parameter (set as a first encoding configuration parameter) of a switching stream, generate a first representation based on the first encoding configuration parameter, and generate a second representation based on the second encoding configuration parameter. The first encoding configuration parameter may include playing duration (set as first playing duration) of a segment (set as a first representation segment) of the first representation, a first spatial object corresponding to the first representation, and the like. The second encoding configuration parameter may include playing duration (set as a second playing duration) of a segment in the second representation (set as a second representation segment), a second spatial object corresponding to the second representation, and the like. The server may add the flag information to the MPD when generating the MPD, where the flag information is used to identify the switching stream in the video. The client may parse the MPD sent by the server and differentiate between the switching stream and the viewport stream based on the flag information. A stream described in a rep carrying the flag information may be a switching stream, or carrying the flag information is a segment in a switching stream, and the like. The flag information may be a flag (or referred to as a representation type flag) of a stream type, playing duration of a segment, information about a switching point, and the like. the server may use the flag information to describe, in a switching stream, information about a segment position at which the client can switch from the switching stream to the viewport stream, or describe, in an MPD, information about a segment position at which the client can switch from the switching stream to the viewport stream. One or more position points (or referred to as switching points, which may be positions of segments between which the client can switch) at which the client can switch to the viewport stream exist in a plurality of segments in the switching stream. The client may switch from the viewport stream to the switching stream corresponding to the viewport stream in segments at specified switching positions included in the switching stream. The client switches from the stream to a segment in the viewport stream at a position of a segment at a specified switching position in the switching stream. Video content before stream switching and video content after stream switching are contiguous. In addition, segments in different viewport streams are aligned, and segments in different switching streams are also aligned. Therefore, the client can switch between segments in different switching streams freely. Video content before switching between the switching stream and the viewport stream and video content after switching are contiguous. video content played after switching is closely connected to video content played before switching. FIG. 11 is another schematic diagram of segments in a DASH stream. A rep A, a rep B, a rep C, and a rep D are respectively viewport streams corresponding to spatial objects A, B, C, and D (correspond to the sub-viewports in FIG. 9). A rep A′ is one switching stream in a group of switching streams corresponding to the spatial object A. The rep A′ and the rep A correspond to the same sub-viewport. The rep A′ may be a switching stream corresponding to the rep A. Similarly, a rep B′ may be a switching stream corresponding to the rep B, a rep C′ may be a switching stream corresponding to the rep C, and a rep D′ may be a switching stream corresponding to the rep D. Segments in the rep A, the rep B, the rep C, and the rep D are aligned, and the client can switch freely (that is, seamless content switching) at a playing end moment (which is also a playing start moment of a next segment) of each segment based on viewport switching. Segments in the rep A′, the rep B′, the rep C′, and the rep D′ are aligned, and the client can switch freely at a playing end moment (which is also a playing start moment of a next segment) of each segment based on viewport switching. The client can switch from the viewport stream to the switching stream at a specified segment in a switching stream, for example, a specified segment (a second segment in a switching stream, where T2 is a playing start moment of the segment) corresponding to T2 shown in FIG. 11. The client can switch from the switching stream to a segment in the viewport stream at a specified switching point, for example, T3 or T4 shown in FIG. 11. T3 is a playing start moment of the second segment in the viewport stream.

In some feasible implementations, after the server prepares the viewport streams of the video data and the switching stream corresponding to each viewport stream, the viewport streams and the switching streams are described in the MPD. The client requests the MPD from the server to parse the MPD sent by the server and obtain the flag information of the switching stream from the MPD. The client may further obtain, from the MPD, viewport stream information of the viewport streams, for example, viewport stream information of the viewport streams such as the rep A, the rep B, the rep C, and the rep D. The viewport stream information may include duration of each segment in the viewport streams, a related URL of each segment, and the like. For details, refer to the segment information described in the DASH standard. The client may further obtain, from the MPD, switching stream information of the switching streams, for example, switching stream information of the switching streams such as the rep A′, the rep B′, the rep C′, and the rep D′. The switching stream information may include duration of each segment in the switching stream, a related URL of each segment, and the like. In addition, the switching stream information further includes the flag information used to identify the switching stream. The representation type flag is used to identify the first representation. If a spatial object switching instruction is received, the client preferentially selects a segment in a specified first representation corresponding to a specified spatial object of spatial object switching for video content switching. The client may alternatively determine a switching stream and a viewport stream in a video based on playing duration of a segment in a stream. The switching point information is used to identify the switching segment information for seamless content switching between the switching stream and the viewport stream, and the switching segment information includes: a switching stream segment interval of switching from the switching stream to the viewport stream, a switching stream segment position for switching from the switching stream to the viewport stream, a viewport stream segment position for switching from the switching stream to the viewport stream, and the like. In a implementation, the flag information may be carried in attribute information (for example, attribute information of the adaptation set) of a stream set including a switching stream carried in the media presentation description; or the flag information is carried in attribute information (for example, attribute information of the representation) of a switching stream carried in the media presentation description; or is carried in attribute information (for example, attribute information of the segment) of a stream segment in a switching stream carried in the media presentation description. In a implementation, the flag information may be alternatively carried in an index segment in a target switching stream to which video content switching needs to be performed.

In some feasible implementations, the representation type flag may be a syntax element added to the MPD, and is used to identify that a stream of a rep description carrying foregoing syntax element is a switching stream. In a implementation, the client may use the syntax element added to the MPD to rapidly identify a switching stream and a viewport stream, so that during viewport switching, the target switching stream corresponding to the target spatial object of viewport switching is selected from the switching streams. The client enters a new viewport rapidly to present video data of the new viewport. The syntax element may include: FovType, FovGroup, FOV_group_change_Info, and the like. Description manners of the several feasible MPD syntax elements are described below:

Manner 1:

Table 2 is an attribute information table of a syntax element:

TABLE 2

| | Character | |
|---|---|---|
| Character | attribute | Character description |
| (Parameters) | (Use) | (Description) |
| FovType | O | Indicate whether a corresponding description is |
| | | a switching stream, and a default value is 0; |
| | | 0 indicates a non-switching stream (that is, a |
| | | viewport stream) |
| | | 1 indicates a switching stream |

Legend (Legend):
M = Mandatory (mandatory),
O = Optional (optional)

The client may parse an MPD of a video stream. If it is obtained by parsing the MPD that a representation carries the character FovType, where a value of FovType is not described in a limitative manner, and it may be determined that a stream described in the representation is a switching stream. In a case of a switching stream, when parameters such as a viewport and a bitrate are the same, the client preferentially selects the representation to present a new viewport, so that switching efficiency of fields of view can be improved and user experience is enhanced.

MPD Example 1:

<?xml version=“1.0” encoding=“UTF-8”?>

<MPD

xmlns:xsi=“http://www.w3.org/2001/XMLSchema-instance”
xmlns=“urn:mpeg:dash:schema:mpd:2011”
xsi:schemaLocation=“urn:mpeg:dash:schema:mpd:2011
DASH-MPD.xsd”
[...]>
<Period>
<AdaptationSet [...]>

<SupplementalProperty schemeIdUri=”“urn:mpeg:dash:xx:201x”

value=“1, 0, 0, 1920, 1080, 1920, 1080, 1”/>

<Representation id=“1” bandwidth=“1000000” >

<BaseURL>video-1.mp4</BaseURL>

</Representation>

</AdaptationSet>

<AdaptationSet [...]>

<EssentialProperty schemeIdUri=“urn:mpeg:dash:xx:201x”

value=“1, 0, 0, 1920, 1080, 3840, 2160, 2”/>

<!--Non-switching stream-->
<Representation id=“2” bandwidth=“4500000”>

<BaseURL>video-2.mp4</BaseURL>

</Representation>
<!--Switching stream-->
<Representation id=“3” bandwidth=“4500000” fovType=“1”>

<BaseURL>video-3.mp4</BaseURL>

</Representation>

</AdaptationSet>

</Period>
</MPD>

In this MPD example, a representation whose representation id is equal to “3” carries “fovType=”1″, indicating that a stream in the representation whose representation id is equal to “3” is a switching stream. A representation whose representation id is equal to “2” has default “fovType”, and “fovType” is equal to 0 by default, indicating that a stream in the representation whose representation id is equal to “2” is a viewport stream. Other descriptions in the example have the same format as related MPD descriptions provided in the DASH standard. For details, refer to descriptions provided in the DASH standard, and the other descriptions are not limited herein. For related descriptions of the examples in the following, refer to descriptions provided in the DASH standard, and details are not described hereinafter.

MPD Example 2:

<?xml version=“1.0” encoding=“UTF-8”?>

<MPD

xmlns:xsi=“http://www.w3.org/2001/XMLSchema-instance”
xmlns=“urn:mpeg:dash:schema:mpd:2011”
xsi:schemaLocation=“urn:mpeg:dash:schema:mpd:2011
DASH-MPD.xsd”
[...]>
<Period>
<AdaptationSet [...]>

<SupplementalProperty schemeIdUri=“urn:mpeg:dash:xx:201x”

value=“1, 0, 0, 1920, 1080, 1920, 1080, 1”/>

<Representation id=“1” bandwidth=“1000000” >

<BaseURL>video-1.mp4</BaseURL>

</Representation>

```
  </AdaptationSet>
  <AdaptationSet id=“1”[...]> <!--Non-switching stream-->
```

<EssentialProperty schemeIdUri=“urn:mpeg:dash:xx:201x”

value=“1, 0, 0, 1920, 1080, 3840, 2160, 2”/>

<Representation id=“2” bandwidth=“4500000”>

<BaseURL>video-2.mp4</BaseURL>

</Representation>

</AdaptationSet>
<AdaptationSet id=“2” [...] fovType=“1”> <!--Switching stream-->

<EssentialProperty schemeIdUri=“urn:mpeg:dash:xx:201x”

value=“1, 0, 0, 1920, 1080, 3840, 2160, 2”/>

<Representation id=“3” bandwidth=“4500000” >

<BaseURL>video-3.mp4</BaseURL>

</Representation>

</AdaptationSet>

</Period>
</MPD>

In this MPD example, attribute information of an adaptation set whose adaptation set id is equal to “2” carries fovType, indicating that streams described in all reps in lower layers of the adaptation set whose adaptation set id is equal to “2” are switching streams. Attribute information of an adaptation set whose adaptation set id is equal to “1” has default fovType, and “fovType” is equal to 0 by default, indicating that none of streams described in all reps in lower layers of the adaptation set whose adaptation set id is equal to “1” is a switching stream.

Manner 2:

Table 3 is an attribute information table of another syntax element:

TABLE 3

| Parameters | Use | Description |
|---|---|---|
| switch- | O | Used to describe a representation, indicating that |
| representation | | a stream described by switch-representation is a |
| | | switching stream |

Legend:
M = Mandatory,
O = Optional

The foregoing representation marked with switch-representation has the same content as other representations that belong to one same adaptation set as the representation. However, Seamless switching cannot be performed between all segments in the representation and segments in other representations. Switching can be performed between the representation and other representations at a specified segment, indicating that the representation is a switching stream. During viewport switching, the client first obtains a segment in the representation for presentation of a new viewport.

MPD Example 3:

<?xml version=“1.0” encoding=“UTF-8”?>

<MPD

xmlns:xsi=“http://www.w3.org/2001/XMLSchema-instance”
xmlns=“urn:mpeg:dash:schema:mpd:2011”
xsi:schemaLocation=“urn:mpeg:dash:schema:mpd:2011
DASH-MPD.xsd”
[...]>
<Period>
<AdaptationSet [...]>

<SupplementalProperty schemeIdUri=“urn:mpeg:dash:xx:201x”

value=“1, 0, 0, 1920, 1080, 1920, 1080, 1”/>

<Representation id=“1” bandwidth=“1000000” >

<BaseURL>video-1.mp4</BaseURL>

</Representation>

</AdaptationSet>

<AdaptationSet [...]>

<EssentialProperty schemeIdUri=“urn:mpeg:dash:xx:201x”

value=“1, 0, 0, 1920, 1080, 3840, 2160, 2”/>

<!--Non-switching stream-->
<Representation id=“2” bandwidth=“4500000”>

<BaseURL>video-2.mp4</BaseURL>

</Representation>
<!--Switching stream-->
< switch-representation id=“3” bandwidth=“4500000” >

<BaseURL>video-3.mp4</BaseURL>

</Representation>

</AdaptationSet>

</Period>
</MPD>

In this MPD example, a new representation type switch-representation is added, where the switch-representation may be a type flag of a description layer to which a switching stream belongs. A stream in a representation whose switch-representation id is equal to “3” is a switching stream.

Manner 3:

Anew syntax FovGroup is added to the MPD to group representations. One group includes viewport streams, that is, streams in existing representations. Another group includes added streams, that is, switching streams.

MPD Example 4:

<?xml version=“1.0” encoding=“UTF-8”?>

<MPD

xmlns:xsi=“http://www.w3.org/2001/XMLSchema-instance”
xmlns=“urn:mpeg:dash:schema:mpd:2011”
xsi:schemaLocation=“urn:mpeg:dash:schema:mpd:2011 DASH-MPD.xsd”
[...]>
<Period>

<AdaptationSet [...]>

<SupplementalProperty schemeIdUri=“urn:mpeg:dash:srd:2014”

value=“1, 0, 0, 1920, 1080, 1920, 1080, 1”/>

<Representation id=“1” bandwidth=“1000000” >

<BaseURL>video-1.mp4</BaseURL>

</Representation>

</AdaptationSet>

<AdaptationSet [...]>

<EssentialProperty schemeIdUri=“urn:mpeg:dash:srd:2014”

value=“1, 0, 0, 1920, 1080, 3840, 2160, 2”/>

<!--Non-switching stream-->

<Representation id=“2” bandwidth=“450000” FovGroup=“1”> >

<BaseURL>video-2.mp4</BaseURL>

</Representation>

<!--Switching stream-->
<Representation id=“3” bandwidth=“4500000” FovGroup =“2” fovType=“1”>

<BaseURL>video-3.mp4</BaseURL>

</Representation>

</AdaptationSet>
<AdaptationSet [...]>

<EssentialProperty schemeIdUri=“urn:mpeg:dash:srd:2014”

value=“1, 1920, 0, 1920, 1080, 3840, 2160, 2”/>

<!--Non-switching stream-->
<Representation id=“4” bandwidth=“450000” FovGroup=“1”>

<BaseURL>video-4.mp4</BaseURL>

</Representation>
<!--Switching stream-->
<Representation id=“5” bandwidth=“4500000” FovGroup =“2”>

<BaseURL>video-5.mp4</BaseURL>

</Representation>

</AdaptationSet>

</Period>

</MPD>

In the MPD, grouping information is added to representations, and groups in which segments between which the client can switch freely are determined based on the grouping information. When FovGroup is equal to “2”, a group of switching streams are marked. When FovGroup is equal to “1”, a group of viewport streams are marked. The client can switch freely between representations in each group. That is, the client can switch freely between segments in representations that are viewport streams, and the client can switch freely between segments in representations that are switching streams. The client can switch between representations that belong to different groups only at a specified segment. For example, FovGroup in a representation whose representation id is equal to “3” and FovGroup in a representation whose representation id is equal to “5” are equal to “2”. The two representations both describe switching streams. The segments in the two representations are all aligned, and the client can switch seamlessly between the segments.

In some feasible implementations, the flag information carried in the MPD may be an existing syntax element, for example, a playing duration (duration) attribute corresponding to a segment, in the MPD. The client may parse the playing duration (duration) attribute corresponding to a segment included in the MPD and uses a stream whose playing duration of a segment is the shortest as a switching stream.

In some feasible implementations, after parsing an MPD of a video stream and determining stream types described in representations in the MPD, the client may perform an operation of requesting and playing related viewport streams based on a viewport used by the user to watch a video, and switching between a viewport stream and a switching stream for playing, or the like. In a implementation, after performing decoding to obtain viewport stream information of viewport streams corresponding to fields of view, the client may first determine, based on a viewport (set as a first viewport) used by the user currently to watch the video, a spatial object (set as a current spatial object) corresponding to the first viewport, so that a first viewport stream (or referred to as a current viewport stream) corresponding to the first viewport can be determined based on spatial objects corresponding to the viewport streams described in the MPD. Further, the client may request the first viewport stream from the server based on viewport stream information of the first viewport stream. After receiving the request of the client, the server may send the first viewport stream to the client. After receiving the first viewport stream, the client may decode and play the first viewport stream. For example, assuming that the first viewport stream is the rep D in FIG. 10, after obtaining the rep D, the client may start to play the rep D from the first segment (which may be marked as a segment D1) of the rep D.

In a implementation, in this embodiment of the present disclosure, the flag information carried in the MPD may be alternatively carried in an .m3u8 file defined based on HTTP Live Streaming (Http Live Streaming, HLS) or an .ismc file defined based on smooth streaming (Smooth Streaming, IS), and may be determined according to a requirement in an actual application scenario and is not limited herein. In this embodiment of the present disclosure, an example in which the flag information is carried in a DASH stream is used for description.

S802: Obtain switching instruction information.

S803: Determine a target representation from a first representation of a video based on the flag information and the switching instruction information.

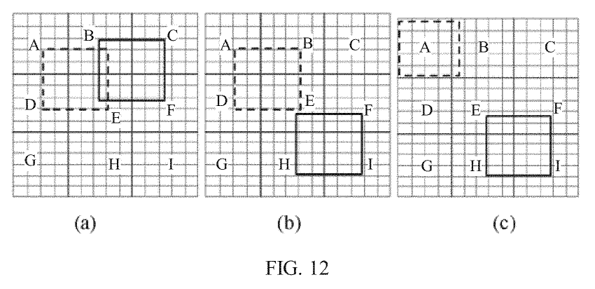

In some feasible implementations, FIG. 12 is another schematic diagram of a spatial object change corresponding to a viewport change. As described in the figure, a space presented in a VR video is divided into nine spatial objects including a spatial object A to a spatial object I. A group of viewport streams and a group of switching streams are prepared for each spatial object. Dotted-line boxes in FIG. 12(a), FIG. 12(b), and FIG. 12(c) may represent currently presented spatial objects (that is, current spatial objects), and solid-line boxes may represent spatial objects (that is, target spatial objects) presented after switching.

In FIG. 12(a), a viewport corresponding to the current spatial object includes the spatial objects A, B, D, and E, and a viewport corresponding to the switch-to target spatial object may include the spatial objects B, C, E, and F, or a viewport corresponding to the switch-to target spatial object may alternatively include the spatial objects C and F. This is not limited herein. In FIG. 12(b), a viewport corresponding to the current spatial object includes the spatial objects A, B, D, and E, and a viewport corresponding to the switch-to target spatial object may include the spatial objects E, F, H, and I, or a viewport corresponding to the switch-to target spatial object may include the spatial objects F, H, and, I. This is not limited herein. In FIG. 12(c), a viewport corresponding to the current spatial object may include the spatial objects A and B, and a viewport corresponding to the switch-to target spatial object includes the spatial objects E, F, H, and I. This is not limited herein. Video content switching induced by spatial object switching is described below with reference to step 704.

S804: Obtain a current playing moment of the video, and obtain a target representation segment based on the current playing moment and the target representation.

In some feasible implementations, when playing the first viewport stream, the client may monitor the viewport used by the user to watch the video. If a viewport switching instruction (that is, the switching instruction information of switching from the current video space to the target spatial object is detected) is received, a target viewport stream (the rep B shown in FIG. 11) that requires switching may be determined based on new viewport information carried in the viewport switching instruction information. In a implementation, the new viewport information carried in the viewport switching request may be the target spatial object of viewport switching. The client may select, based on spatial objects corresponding to the viewport streams described in the MPD, the target viewport stream corresponding to the target spatial object from the viewport streams in the video stream. Further, the client may further determine, according to indication information corresponding to the switching streams described in the MPD, a switching stream (that is, the target stream, or referred to as a target representation) corresponding to the target spatial object, so that the target switching stream (the rep B′ shown in FIG. 11) corresponding to the target viewport can be selected from the switching streams.

In some feasible implementations, after determining a representation (that is, a target representation, referred to as a target switching stream) that needs to be requested, the client constructs, based on target switching stream information described in the MPD, a URL of a segment to be requested, so that a target segment may be requested from the server based on the URL, to obtain and play the target segment. In a implementation, the client may obtain segment information of the segments in the target switching streams described in the MPD. The segment information may include playing duration (referred to as duration for short hereinafter) corresponding to the segments. The client may calculate playing start moments of the segments based on the duration information. Alternatively, the client calculates a playing start moment of each segment based on duration information of a segment in a sidx box. Therefore, the client may select, from the segments in the target switching stream based on a moment (that is, a moment at which the current viewport is switched to the target spatial object, and may be marked as a switching trigger moment or a current playing moment) of receiving the viewport switching request, a segment whose playing start moment is closest to the switching trigger moment, and determine the playing start moment of the segment (that is, a first target segment, and set as a first segment) as a moment (set as a first moment) of switching from the first viewport stream to the target switching stream. After determining the first segment, the client constructs a URL of a first segment and sends a request of the URL to the server. After receiving the request from the client, the server may send segment data of the segment to the client. For example, in FIG. 11, the client receives a viewport switching request at a moment T1, so that after determining the first segment (assumed as the second segment in the rep B′), the client may switch to play video data of the first segment at a moment T2.

It should be noted that the target switching stream is a switching stream corresponding to a target viewport stream. Video content included in the target switching stream is the same as video content included in the target viewport stream, and the playing duration of the segment in the target switching stream is shorter than the playing duration of the segment in the target viewport stream. Because duration of a segment in a switching stream is shorter than duration of a segment in a viewport stream, the client does not need to wait till playing of a current segment (for example, a segment D1) in a current viewport stream is implemented before the client can switch to a new viewport, that is, switch to a first segment (assumed as the second segment in the rep B′), thereby improving switching efficiency of stream segments. In a implementation, video content included in a switching stream is the same as video content included in a viewport stream corresponding to the switching stream, and in addition, quality of the video data in the switching stream may also be the same as quality of the video data included in the viewport stream corresponding to the switching stream, or quality of the video data in the switching stream is slightly poorer than quality of video data included in the viewport stream corresponding to the switching stream. Therefore, it can be ensured that after rapid switching, a new viewport with a video image having relatively high quality is presented to a user, discomfort that the user feels due to latency is avoided, and user experience of VR video watching is enhanced.

In some feasible implementations, after switching the played video data from the first viewport stream to the target switching stream, the client may request a target viewport stream from the server based on target viewport stream information carried in the MPD. In a implementation, the client may obtain description information (or referred to as segment information) of a switching stream in the MPD. The description information includes segment duration information of the switching stream, spatial information of the switching stream, and the like. The segment duration information of the switching stream describes duration of a segment in the switching stream. The spatial information describes a spatial object corresponding to the switching stream. The client may further obtain description information of the target viewport stream in the MPD. The description information includes segment duration information of the target viewport stream, spatial information, and the like. The segment duration information of the viewport stream describes duration of a segment in the viewport stream. The spatial information describes a spatial object corresponding to the viewport stream. The client calculates a start playing time of each segment by using the duration of the segment in the target viewport stream. By using the spatial information, the client determines the viewport stream that has a same viewport as that of the switching stream, and finds, in the viewport stream, a segment whose playing start time is closest to a current playing time, so that the playing start moment of the segment can be determined as a second moment. The client may request the segment from the server based on a URL of the segment, and receives and decodes the segment, so that the client can switch to the segment at the second moment for playing.

Further, in some feasible implementations, the client may calculate a start playing time of each segment in the viewport stream by using the duration of the segment in the viewport stream, and calculate a start playing time of each segment in the switching stream by using the duration of a segment in the switching stream. Further, the client may determine a position of a segment having aligned playing start moments in the target viewport stream and the target switching stream. When the playing start moments are aligned, it means that during switching from the switching stream to the viewport stream at the position of the segment, played video content before switching and played video content after switching are contiguous and are not repetitive. The client may request the segment from the server based on the URL of the segment, and receive and decode the segment, so that the client can switch to the segment at the second moment for playing.

Further, in some feasible implementations, the client may alternatively switch between the target switching stream and the target viewport stream based on the switching point information described in the MPD. The MPD of the video stream generated by the server marks the switching stream, and may further mark a position at which the client can switch from each switching stream to the viewport stream. the MPD marks information about a switching point between the switching stream and the viewport stream. Table 4 is a description table of indication information of a switching point between a viewport stream and a switching stream:

TABLE 4

| Parameters | Use | Description |
|---|---|---|
| FOV_group_change_Info | O | Describe indication information of a |
| | | switching point between a viewport |
| | | stream and a switching stream |

Legend:
M = Mandatory,
O = Optional

The FOV_group_change_Info is used to mark information such as a switching point of switching from the switching stream to the viewport stream. The switching point information is used to identify switching segment information for performing seamless content switching between the first representation (that is, a switching stream) and the second representation (that is, a viewport stream). The switching segment information includes: a first representation segment interval of switching from the first representation to the second representation, a first representation segment position of switching from the first representation to the second representation, and a second representation segment position of switching from the first representation to the second representation, and the like. A specific MPD example is used for description below, and the specific MPD example is as follows:

MPD Example 5:

<?xml version=“1.0” encoding=“UTF-8”?>

<MPD

xmlns:xsi=“http://www.w3.org/2001/XMLSchema-instance”
xmlns=“urn:mpeg:dash:schema:mpd:2011”
xsi:schemaLocation=“urn:mpeg:dash:schema:mpd:2011 DASH-MPD.xsd”
[...]>
<Period>

<AdaptationSet [...]>

<SupplementalProperty schemeIdUri=“urn:mpeg:dash:srd:2014”

value=“1, 0, 0, 1920, 1080, 1920, 1080, 1”/>

<Representation id=“1” bandwidth=“1000000” >
<BaseURL>video-1.mp4</BaseURL>
</Representation>

</AdaptationSet>
<AdaptationSet [...]>

<EssentialProperty schemeIdUri=“urn:mpeg:dash:srd:2014”

value=“1, 0, 0, 1920, 1080, 3840, 2160, 2”/>

<!--Non-switching stream-->
<Representation id=“2” bandwidth=“450000”>

< SegmentList >

<SegmentURL media=“seg-m1-1.mp4”/>
<SegmentURL media=“seg-m1-2.mp4”/>

</ SegmentList >

```
  </Representation>
<!--Switching stream-->
  <Representation id=“3” bandwidth=“4500000” fovType=“1”>
```

```
  < SegmentList >
  <SegmentURL media=“seg-m1-1.mp4”/>
  <SegmentURL media=“seg-m1-2.mp4”/>
  <SegmentURL media=“seg-m1-3.mp4” FOV_group_change_Info=“2” />
  </ SegmentList >
```

</Representation>

</AdaptationSet>
</Period>

</MPD>

In this MPD example, a stream whose representation id is equal to “3” is a switching stream (set as a target switching stream, that is, a target stream). The client can switch to a viewport stream (set as a target viewport stream) at a segment (a first target stream segment) corresponding to Segment URL media=“seg-m1-3.mp4”, and FOV_group_change_Info=“2” may directly indicate that the client can switch from the switching stream to the second segment (that is, a second target stream segment) of the viewport stream. FOV_group_change_Info=“2” indicates a position of a target second representation segment of switching from a target first representation to the target second representation. After parsing the MPD to obtain the flag information, the client may directly determine the second target stream segment from the flag information. A moment of switching from the switching stream to the viewport stream may be determined based on a playing start moment of the second segment in the viewport stream.

MPD Example 6:

<?xml version=“1.0” encoding=“UTF-8”?>

<MPD

xmlns:xsi=“http://www.w3.org/2001/XMLSchema-instance”
xmlns=“urn:mpeg:dash:schema:mpd:2011”
xsi:schemaLocation=“urn:mpeg:dash:schema:mpd:2011 DASH-MPD.xsd”
[...]>
<Period>

<AdaptationSet [...]>

<SupplementalProperty schemeIdUri=“urn:mpeg:dash:srd:2014”

value=“1, 0, 0, 1920, 1080, 1920, 1080, 1”/>

<Representation id=“1” bandwidth=“1000000” >
<BaseURL>video-1.mp4</BaseURL>
</Representation>

</AdaptationSet>
<AdaptationSet [...]>

<EssentialProperty schemeIdUri=“urn:mpeg:dash:srd:2014”

value=“1, 0, 0, 1920, 1080, 3840, 2160, 2”/>

<!--Non-switching stream-->
<Representation id=“2” bandwidth=“450000”>

< SegmentList >

<SegmentURL media=“seg-m1-1.mp4”/>
<SegmentURL media=“seg-m1-2.mp4”/>

</ SegmentList >

```
  </Representation>
<!--Switching stream-->
  <Representation id=“3” bandwidth=“4500000” FOV_group_change_Info=“4” >
```

```
  < SegmentList >
  <SegmentURL media=“seg-m1-1.mp4”/>
  <SegmentURL media=“seg-m1-2.mp4”/>
  <SegmentURL media=“seg-m1-3.mp4”/>
  </ SegmentList >
```

</Representation>

</AdaptationSet>

</Period>

</MPD>

In a implementation, FOV_group_change_Info in the MPD example 6 may further represent an interval of segments between which the client can switch, a first representation segment interval of switching from the target first representation to the target second representation. For example, when FOV_group_change_Info is equal to 4, it indicates that the client can switch to the viewport stream at an interval of four segments in the switching stream. In the semantics, the client may parse the MPD to obtain the FOV_group_change_Info information to determine switching segment position information of switching from each switching stream to a viewport stream corresponding to the switching stream, so that the client may determine, based on the switching segment position information, a segment at which the client switches from a switching stream to a viewport stream corresponding to the switching stream. If the switching stream includes more than one switching stream segment, the client may select a switching segment whose playing start moment is closest to the target switching stream as a target first representation segment, that is, a segment at which the client switches from the target switching stream to the target viewport stream. In this semantics, FOV_group_change_Info may be placed in a syntax layer of an adaptation set or a representation, which may be determined according to an actual application scenario and is not limited herein.

After determining, based on the MPD description, the target switching stream corresponding to the target viewport stream, the client may request the target switching stream from the server, and after the switching point information for switching from the switching stream to the viewport stream is detected, according to the indication of the switching point information, the client requests a second target stream segment in the target viewport stream, and presents the segment at a playing start moment of the segment.

In a implementation, the switching point information between the viewport stream and the switching stream may be further described in a sixd box (index segment, index segment) data of a stream. A description of a syntax format of the sixd box in ISO/IEC 14496-12 is as follows:

aligned(8) class SegmentIndexBox extends FullBox(‘sidx’, version, flag) {

unsigned int(32) reference_ID;
unsigned int(32) timescale;
if (version==0) {

unsigned int(32) earliest_presentation_time;
unsigned int(32) first_offset;
}
else {
unsigned int(64) earliest_presentation_time;
unsigned int(64) first_offset;
}

unsigned int(16) reserved = 0;
unsigned int(16) reference_count;
for(i=1; i <= reference_count; i++)
{

| bit (1) reference_type; | |
|---|---|
| unsigned int(31) referenced_size; | |
| unsigned int(32) subsegment_duration; | |
| bit(1) starts_with_SAP; | |
| unsigned int(3) SAP_type; | |
| unsigned int(28) SAP_delta_time; | |
| unsigned int(8) | FOV_group_change_Info; |

}

}

Meanings represented by syntax elements included in the description are as follows:

reference_ID: an ID of a stream;

timescale: a time unit;

earliest_presentation_time: an earliest presentation time of a stream described in an index segment, where a timescale is used as a unit;

first_offset: a start offset of a first segment after an index segment;

reference_count: a quantity of segments described in an index segment;

reference_type: 1 indicates that a segment is an index segment, and 0 indicates that a segment is media content;

referenced_size: a size of a segment;

subsegment_duration: duration of a segment using a timescale as a unit;

starts_with_SAP: a stream access type of a segment; and

SAP_delta_time: an earliest presentation time of a first stream access point.

FOV_group_change_Info: switching point flag information, indicating that the client can switch from a current segment (segment, that is, the target first representation segment) to any other representation (representation) having a same content component, that is, a position of a target first representation segment of switching from the target first representation to the target second representation.

FOV_group_change_Info may represent two meanings as follows:

1. The FOV_group_change_Info information may indicate whether the client can switch from a current segment to a segment in another rep carrying attribute information such as Duration/FOVGroup/FovType.indication information of a viewport stream to which the client can switch from the current segment may be further described in segment information of a segment carrying the information, and the viewport stream corresponding to the switching stream may be determined by using the indication information of the viewport stream.

For example, in the MPD examples 1 to 3 in the foregoing implementations, a stream file video-3.mp4 whose representation id is equal to “3” includes the sidx box. It is obtained by parsing the box that FOV_group_change_Info of an n^{th} segment is 1, indicating that the client can switch from the segment to another representation having a same content component. In the foregoing examples 1 to 3, a stream whose representation id is equal to “2” and a stream whose representation id is equal to “3” have the same viewport (the stream whose representation id is equal to “2” is merely an example, and a viewport stream corresponding to the segment may be determined according to an actual application scenario). Therefore, the client can switch from a representation whose representation id is equal to “3” to a representation whose representation id is equal to “2” at a position of an n^{th} segment, and otherwise switching cannot be performed. In the MPD example 4, if FovGroup is equal to “2” when a representation id is equal to “3”, and it is obtained by parsing a sidx box that FOV_group_change_Info of an n^{th} segment is 1, it indicates that the client can switch from a stream whose representation id is equal to “3” to a representation whose attribute FOVGroup is equal to 1 (that is, a viewport stream, where a stream whose rep id is equal to “2” is used as an example) at the position of the n^{th} segment.

2. The FOV_group_change_Info information may be alternatively a value of an ID of another segment of another bitrate that carries attribute information such as

Duration/FOVGroup/FovType and to which the client can switch from the current segment carrying the information. For example, when FOV_group_change_Info is equal to 4, it indicates that the client can switch from the current segment to the fourth segment in the viewport stream.

In a implementation, the switching point information between the viewport stream and the switching stream may be further described in another new box, for example:

aligned(8) class SegmentSwitchBox extends FullBox(‘sswx’, version, flag) {

unsigned int(16) reference_count;
for(i=1; i <= reference_count; i++)
{

| | |
|---|---|
| unsigned int(8) | FOV_group_change_Info; |

}

}

Semantics of FOV_group_change_Info are consistent with that in sidx;

The switching point information may be further described as follows:

aligned(8) class SegmentSwitchBox extends FullBox(“sswx’, version,
flag) {

unsigned int(8) FOV_group_change_Info;

}

FOV_group_change_Info: The information represents an interval of switching from a segment in a switching stream to a segment in a viewport stream.

In a implementation, the client may determine, based on the switching point information carried in segment information of the target switching stream, a switching point for switching from the target switching stream to the target viewport stream, so that a target viewport stream is requested from the server based on information such as a URL of the target viewport stream described in the MPD. The segment information of the target switching stream may include switching segment position information of switching from the target switching stream to the target viewport stream, for example, a switching segment position indicated by a value of an element FOV_group_change_Info carried in the MPD, or a segment interval of switching segments indicated by a value in the element FOV_group_change_Info, or the like. The client may determine, based on a segment (set as a first switching segment, for example, the second segment in the rep B′) in a corresponding target switching stream during switching from the current viewport stream to the target switching stream and by combining switching segment position information indicated by the value of FOV_group_change_Info, a target segment (set as a second switching segment) of switching from the target switching stream to the target viewport stream. For example, as shown in FIG. 10, assuming that the segment information of the target switching stream described in the MPD carries indication information indicating that FOV_group_change_Info is equal to 2, it indicates that the client can switch from the fifth segment (marked as a second segment) of the target switching stream to the second segment in the target viewport stream. After determining, according to the indication information indicating that FOV_group_change_Info is equal to 2, the fourth segment in the switching stream of the second viewport, the client may request the second segment in the viewport stream of the second viewport.

In some feasible implementations, the client may calculate a playing start moment of each segment based on duration of the segment in the MPD or duration of the segment in a sidx box, and determine a second moment based on the playing start moment of the segment. For example, the client determines a moment closest to the playing start moment of the segment in the viewport stream and the playing start moment of the segment in the switching stream as a second moment. After determining the second moment, the client may request, from the server, a target segment (the second segment in the rep B shown in FIG. 10, and is marked as a segment B2) of the target viewport stream corresponding to the moment. The second moment may be a playing start moment of the segment B2, or the second moment is closest to the playing start moment of the segment B2. The client may compare the second moment with playing start moments of the segments in the target viewport stream to select a target switching segment such as the segment B2 from the segments, and request the segment from the server. After receiving the segment B2 sent by the server, the client may switch the played video data to the segment B2 when the target switching stream is played to the playing start moment of the segment B2, to present a high-quality video of the second viewport to the user. After the client receives the viewport switching request and before the video data played by the client is switched from the current viewport stream to the target viewport stream, the played video data may be first switched from the current viewport stream to the target switching stream, to present the video image of the new viewport to the user more rapidly. Further, the client may switch the played video data to the target viewport stream at a preset second moment of switching the target switching stream to the target viewport stream. As shown in FIG. 10, when the client plays the segment D1, the user triggers a viewport switching request at the moment T1, and the client may switch to the first segment at the moment T2, so that a picture of a new viewport can be presented to the user within a short time between T1 and T2. The client may switch from the first segment to the segment B2 at a Moment T3, to complete switching from the first viewport to the second viewport. If an existing segment switching method provided in the DASH standard is used, when the user triggers a viewport switching request at a moment T1, the client needs to wait till playing of the segment D1 is implemented before the client can switch to the segment B2 at the moment T3. In this case, the user needs to wait for the new viewport for duration (T3-T1). If (T3-T1) is longer than 200 ms, the user feels discomfort, and user experience is poor.

Further, in some feasible implementations, the segment information of the target switching stream may include one or more switching moments of switching from the target switching stream to the target viewport stream. The switching moment is used to indicate a time point at which the client can switch from a target switching stream to a target viewport stream, and may be represented as a playing start moment of a segment, for example, a playing start moment T3 of the segment B2 and a playing start moment T4 of the segment B3 shown in FIG. 10. The switching moment may be a playing start moment of a segment, for example, a playing start moment of the second segment. a server end may add indication information of a switching moment to a segment information field of a target switching stream described in an MPD or an index segment. After parsing the MPD or index segment, the client may obtain the indication information of the switching moment from the MPD or index segment, and determine a switching moment of switching from the target switching stream to the target viewport stream. After determining switching moments of switching from the target switching stream to the target viewport stream, the client may select a switching moment closest to a first moment from the switching moments as a switching moment (that is, a second moment) of a current time of switching from the target switching stream to the target viewport stream. Further, the client may request, from the server from the segments in the target viewport stream, a segment (for example, the rep B2) whose playing start moment is closest to the second moment, and switch to the segment for playing.

It should be noted that in the foregoing implementation, the first moment may be a playing start moment of the first segment, the second moment may be a playing start moment of the second segment, and the first segment and the second segment are separated by three segments. duration between the first moment and the second moment is N (assumed to be 3) times duration of a stream segment in the target switching stream. In a implementation, N is an integer greater than or equal to 1, may be determined according to an actual application scenario, and is not limited herein.

In this embodiment of the present disclosure, the client may parse the MPD of the video data to determine the viewport stream information of the viewport streams and the switching stream information of the switching streams in the video data. The client may request, from the server based on a current viewport used by the user to watch the video and the determined viewport stream information of the viewport streams, a viewport stream corresponding to the current viewport for playing. After the client receives the viewport switching request and before the video data played by the client is switched from the current viewport stream to the target viewport stream, the played video data may be first switched from the current viewport stream to the target switching stream, to present the video image of the new viewport to the user more rapidly. Further, after determining the second moment of switching from the target switching stream to the target viewport stream, the client may switch the played video data to the target viewport stream when the target switching stream is played to the second moment. This embodiment of the present disclosure provides a switching stream, so that when a terminal user switches fields of view, the client can rapidly switch from a stream to the switching stream to obtain a new viewport having high quality, and the switching point information of the switching stream and the viewport stream is used, so that after requesting a switching stream, the client switches to a viewport stream, thereby ensuring that a stream received by the client has optimal compression performance and ensuring optimal experience of a viewport video under a same bandwidth condition.

FIG. 13 is a schematic structural diagram of a client according to an embodiment of the present disclosure. The client provided in this embodiment of the present disclosure includes:

an obtaining module 131, configured to parse media presentation description to obtain flag information, where the flag information is used to identify a first representation of a video, and playing duration of a segment in the first representation is shorter than playing duration of a segment in a second representation of the video;

a receiving module 132, configured to obtain switching instruction information, where the switching instruction information is used to instruct to switch from a current spatial object to a target spatial object; and

a determining module 133, configured to determine a target representation from the first representation of the video based on the flag information obtained by the obtaining module and the switching instruction information received by the receiving module, where the target representation corresponds to the target spatial object, where

the obtaining module 131 is further configured to: obtain a current playing moment of the video, and obtain a target representation segment based on the current playing moment and the target representation determined by the determining module.

In a feasible implementation, the flag information includes at least one of a representation type flag, playing duration of a representation segment, and switching point information.

In a feasible implementation, the switching point information is used to identify switching segment information for performing representation switching between the first representation and the second representation, where

the switching segment information includes at least one of a segment interval, a segment position of the first representation, and a segment position of the second representation.

In a feasible implementation, the flag information is carried in attribute information of a representation set including the first representation carried in the media presentation description.

In a feasible implementation, the flag information is carried in attribute information of the first representation carried in the media presentation description.

In a feasible implementation, the flag information is carried in attribute information of a segment in the first representation carried in the media presentation description.

In a feasible implementation, the obtaining module is configured to:

obtain segment information of the target representation, where the segment information of the target representation includes playing duration corresponding to segments included in the target representation;

calculate playing start moments of the segments based on the playing duration corresponding to the segments, and determine a first moment based on the playing start moments of the segments and the current playing moment, where the first moment is one of the playing start moments of the segments that is closest to the current playing moment; and

determine a segment whose playing start moment is the first moment as the target representation segment.

In a implementation, the client provided in this embodiment of the present disclosure may be the client in the foregoing embodiments. The client may perform implementations described in the steps in the foregoing embodiments by using the modules embedded in the client. Details are not described herein again.

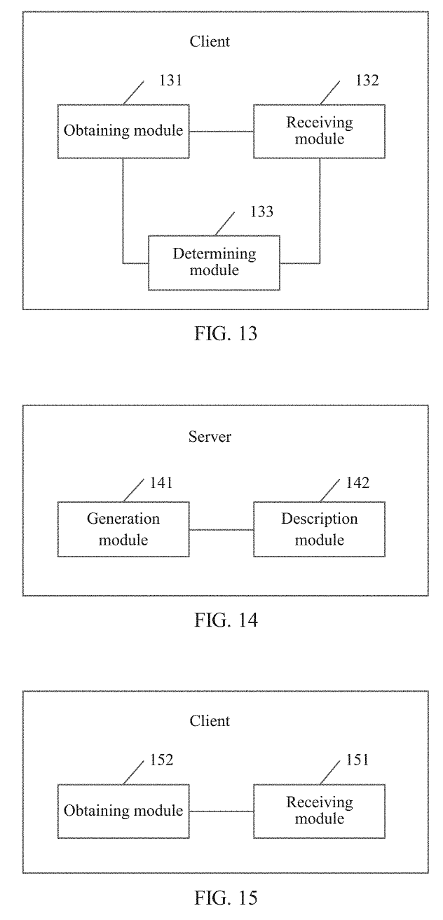

FIG. 14 is a schematic structural diagram of a server according to an embodiment of the present disclosure. The client provided in this embodiment of the present disclosure includes:

a generation module 141, configured to: generate a first representation of a video based on an encoding configuration parameter of a first representation, and generate a second representation of the video based on an encoding configuration parameter of the second representation, where playing duration of a segment in the first representation is shorter than playing duration of a segment in the second representation; and

a description module 142, configured to generate a media presentation description, where the media presentation description carries flag information, and the flag information is used to identify the first representation of the video.

In a feasible implementation, the flag information describes the playing duration of the segment in the first representation and the playing duration of the segment in the second representation, where

the playing duration of the segment in the first representation is shorter than the playing duration of the segment in the second representation of the video.

In a feasible implementation, the flag information describes switching point information of the segments in the first representation and the second representation.

In a feasible implementation, the switching point information is used to identify switching segment information for performing content switching between the first representation and the second representation, where

the switching segment information includes at least one of a segment interval, a segment position of the first representation, and a segment position of the second representation.

In a implementation, the server provided in this embodiment of the present disclosure may be the server in the foregoing embodiment, and may perform implementations described in the steps in the foregoing embodiments by using the modules embedded in the server. Details are not described herein again.

FIG. 15 is another schematic structural diagram of a client according to an embodiment of the present disclosure. The client provided in this embodiment of the present disclosure includes:

a receiving module 151, configured to receive a media presentation description, where the media presentation description includes at least two representations, the representation includes attribute information describing a media data segment, the media presentation description further includes at least two switching stream representations, and the switching stream representation includes attribute information describing a data segment in a switching stream, where spatial objects associated with the at least two representations are in a one-to-one correspondence with spatial objects associated with the at least two switching stream representations, and playing duration corresponding to a media data segment described in a media representation is longer than playing duration corresponding to a data segment in a switching stream described in a switching stream representation corresponding to the media representation; and

an obtaining module 152, configured to obtain switching instruction information, where

the obtaining module 152 is further configured to obtain a target switching stream representation according to the switching instruction information and the media presentation description, where the target viewport switching stream representation is one of the at least two switching stream representations; and

the obtaining module 152 is further configured to obtain target switching stream request information based on the target switching stream representation, where the switching stream request information is used to request some data segments in a target switching stream.

In a feasible implementation, the media presentation description further includes spatial information of a spatial object associated with a switching stream representation, and the spatial information is used to describe a spatial relationship between the spatial object associated with the switching stream representation and a content component associated with the switching stream representation; and

the obtaining module 152 is configured to:

obtain spatial information of a target spatial object according to the switching instruction information; and

obtain the target switching stream representation according to the spatial information of the target spatial object and the spatial relationship.

In a feasible implementation, the media presentation description includes information about an adaptation set, and the adaptation set is used to describe a data set of attributes of media data segments of a plurality of interchangeable encoded versions of a same media content component, where

the information about the adaptation set includes information about the at least two switching stream representations.

In a feasible implementation, the media presentation description includes information about a representation, and the representation is a collection and an encapsulation of one or more streams in a delivery format, where

the information about the representation includes information about the at least two switching stream representations.

In a feasible implementation, the information about the switching stream representation includes at least one of a stream type flag, playing duration of a stream segment, and switching point information.

In a feasible implementation, the switching point information is used to identify switching segment information for performing content switching between a switching stream and a non-switching stream, where

the switching segment information includes at least one of a stream segment interval, a stream segment position of a switching stream, and a stream segment position of a non-switching stream.

In a implementation, the client provided in this embodiment of the present disclosure may be the client in the foregoing embodiments, and may perform implementations described in the steps in the foregoing embodiments by using the modules embedded in the client. Details are not described herein again.

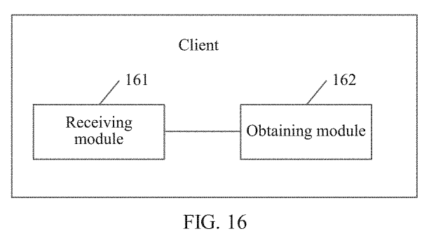

FIG. 16 is another schematic structural diagram of a client according to an embodiment of the present disclosure. The client provided in this embodiment of the present disclosure includes:

a receiving module 161, configured to receive a media presentation description, where the media presentation description includes information about at least two representations, the representation includes at least one segment, and segment duration of a first representation of the at least two representations is shorter than segment duration of a second representation of the at least two representations, where a spatial object associated with the first representation corresponds to a spatial object associated with the second representation; and

an obtaining module 162, configured to obtain switching instruction information, where

the obtaining module 162 is further configured to: obtain, according to the representation switching instruction, the segment in the first representation, and obtain the segment in the second representation after a preset time.

In a feasible implementation, the first representation carries switching point information.

In a feasible implementation, the media presentation description carries flag information, where

the flag information includes at least one of a representation type flag, playing duration of a representation segment, and switching point information.

In a feasible implementation, the switching point information is used to identify switching segment information for performing representation switching between a first stream and a second stream, where

the switching segment information includes at least one of a segment interval, a segment position of the first representation, and a segment position of the second representation.

In a feasible implementation, the carried switching point information is carried in a specified box in the first representation.

In a feasible implementation, the specified box is a sidx box included in the first representation, and the sidx box is used to describe segment information.

In a feasible implementation, the representation type flag is used to identify the first representation.

In a feasible implementation, the media presentation description includes information about an adaptation set, and the adaptation set is used to describe a data set of attributes of media data segments of a plurality of interchangeable encoded versions of a same media content component, where

the information about the adaptation set includes the flag information.

In a feasible implementation, the media presentation description includes information about a representation, and the representation is a collection and an encapsulation of one or more streams in a delivery format, where

the information about the representation includes the flag information.

In a feasible implementation, the media presentation description includes information about a descriptor, and the descriptor is used to describe spatial information of the associated spatial objects, where

the information about the descriptor includes the flag information.

In a implementation, the client provided in this embodiment of the present disclosure may be the client in the foregoing embodiments, and may perform implementations described in the steps in the foregoing embodiments by using the modules embedded in the client. Details are not described herein again.

In the embodiments of the present disclosure, the switching stream and the viewport stream included in the video may be identified based on the flag information carried in the media presentation description. During switching between spatial objects, the target switching stream corresponding to the target spatial object may be identified from the plurality of switching streams of the video based on the target spatial object, the target segment in the target switching stream can be determined based on the video playing moment during spatial object switching, and the target segment is presented. The playing duration of the segment in the switching stream is shorter than the playing duration of the segment in the viewport stream. Therefore, during spatial object switching, the client can first switch to a switching stream segment having relatively short playing duration, so that switching and playing efficiency of segments corresponding to spatial objects can be improved, and user experience can be enhanced. Further, the segment in the target viewport stream corresponding to the target spatial object can be obtained and presented, to complete switching and playing of a segment in a corresponding viewport stream during spatial object switching. After completing intermediate transition of stream switching of a spatial object by using the target switching stream, the client may switch to playing of the target viewport stream, so that stability of video playing after spatial object switching can be ensured, and user experience of video watching can be enhanced.

In the specification, claims, and accompanying drawings of the embodiments of the present disclosure, the terms “first”, “second”, “third”, “fourth”, and so on are intended to distinguish between different objects but do not indicate a particular order. In addition, the terms “including” and “having” and any other variants thereof are intended to cover a non-exclusive inclusion. For example, a process, a method, a system, a product, or a device that includes a series of steps or units is not limited to the listed steps or units, but optionally further includes an unlisted step or unit, or optionally further includes another inherent step or unit of the process, the method, the system, the product, or the device.

Persons of ordinary skill in the art may understand that all or some of the processes of the methods in the embodiments may be implemented by a computer program instructing relevant hardware. The program may be stored in a computer readable storage medium. When the program runs, the processes of the methods in the embodiments are performed. The foregoing storage medium may include: a magnetic disc, an optical disc, a read-only memory (Read-Only Memory, ROM), or a random access memory (Random Access Memory, RAM).

What is disclosed above is merely exemplary embodiments of the present disclosure, and certainly is not intended to limit the protection scope of the present disclosure. Therefore, equivalent variations made in accordance with the claims of the present disclosure shall fall within the scope of the present disclosure.

What is claimed is:

1. A method for processing video data, comprising:
parsing media presentation description to obtain flag information, wherein the flag information is used to identify a first representation of a video, and playing duration of a segment described in the first representation is shorter than playing duration of a segment described in a second representation of the video;
obtaining switching instruction information, wherein the switching instruction information is used to instruct to switch from a current spatial object to a target spatial object;
obtaining a target representation based on the flag information and the switching instruction information, wherein the target representation corresponds to the target spatial object; and
obtaining a current playing moment of the video, and obtaining a target representation segment based on the current playing moment and the target representation.

2. The method according to claim 1, wherein the flag information comprises at least one of a representation type flag, playing duration of a representation segment, or switching point information.

3. The method according to claim 2, wherein the switching point information is used to identify switching segment information for performing representation switching between the first representation and the second representation, wherein
the switching segment information comprises at least one of a segment interval, a segment position of the first representation, and a segment position of the second representation; or
the switching point information is a flag (flag), and the flag is used to indicate a switching capability of a segment.

4. The method according to claim 1, wherein the media presentation description comprises attribute information of a representation set, the attribute information of the representation set comprises the flag information, and the first representation is a representation in the representation set.

5. The method according to claim 1, wherein the media presentation description comprises attribute information of the first representation, and the attribute information of the first representation comprises the flag information.

6. The method according to claim 1, wherein the media presentation description comprises attribute information of the segment described in the first representation, and the attribute information of the segment comprises the flag information.

7. The method according to claim 2, wherein the obtaining a target representation segment based on the current playing moment and the target representation comprises:
obtaining segment information of the target representation, wherein the segment information of the target representation comprises playing duration corresponding to segments comprised in the target representation;
calculating playing start moments of the segments based on the playing duration corresponding to the segments, and determining a first moment based on the playing start moments of the segments and the current playing moment, wherein the first moment is one of the playing start moments of the segments that is closest to the current playing moment; and
determining a segment whose playing start moment is the first moment as the target representation segment.

8. A method for processing video data, wherein the method comprises:
generating, by a server, a first representation of a video based on an encoding configuration parameter of the first representation, and generating a second representation of the video based on an encoding configuration parameter of the second representation, wherein playing duration of a segment described in the first representation is shorter than playing duration of a segment described in the second representation; and
generating, by the server, a media presentation description, wherein the media presentation description comprises flag information, and the flag information is used to identify the first representation of the video.

9. The method according to claim 8, wherein the flag information describes the playing duration of the segment in the first representation and the playing duration of the segment in the second representation.

10. The method according to claim 8, wherein the flag information describes switching point information of the segments in the first representation and the second representation.

11. The method according to claim 9, wherein the switching point information is used to identify switching segment information for performing content switching between the first representation and the second representation, wherein
the switching segment information comprises at least one of a segment interval, a segment position of the first representation, and a segment position of the second representation; or
the switching point information is a flag (flag), and the flag is used to indicate a switching capability of a segment.

12. A client, comprising:
an obtaining module, configured to parse media presentation description to obtain flag information, wherein the flag information is used to identify a first representation of a video, and playing duration of a segment described in the first representation is shorter than playing duration of a segment described in a second representation of the video;
a receiving module, configured to obtain switching instruction information, wherein the switching instruction information is used to instruct to switch from a current spatial object to a target spatial object;
a determining module, configured to obtain a target representation based on the flag information obtained by the obtaining module and the switching instruction information received by the receiving module, wherein the target representation corresponds to the target spatial object, wherein
the obtaining module is further configured to: obtain a current playing moment of the video, and obtain a target representation segment based on the current playing moment and the target representation obtained by the determining module.

13. The client according to claim 12, wherein the flag information comprises at least one of a representation type flag, playing duration of a representation segment, and switching point information.

14. The client according to claim 13, wherein the switching point information is used to identify switching segment information for performing representation switching between the first representation and the second representation, wherein
the switching segment information comprises at least one of a segment interval, a segment position of the first representation, and a segment position of the second representation; or
the switching point information is a flag (flag), and the flag is used to indicate a switching capability of a segment.

15. The client according to claim 12, wherein the media presentation description comprises attribute information of a representation set, the attribute information of the representation set comprises the flag information, and the first representation is a representation in the representation set.

16. The client according to claim 12, wherein the media presentation description comprises attribute information of the first representation, and the attribute information of the first representation comprises the flag information.

17. The client according to claim 12, wherein the media presentation description comprises attribute information of the segment described in the first representation, and the attribute information of the segment comprises the flag information.

18. The client according to claim 13, wherein the obtaining module is configured to:
obtain segment information of the target representation, wherein the segment information of the target representation comprises playing duration corresponding to segments comprised in the target representation;
calculate playing start moments of the segments based on the playing duration corresponding to the segments, and determine a first moment based on the playing start moments of the segments and the current playing moment, wherein the first moment is one of the playing start moments of the segments that is closest to the current playing moment; and
determine a segment whose playing start moment is the first moment as the target representation segment.
